(19) United States
(12) Patent Application Publication
(10) Pub. No.: US 2025/0293254 A1
(43) Pub. Date: Sep. 18, 2025

(54) SECONDARY BATTERY

(71) Applicant: MURATA MANUFACTURING CO., LTD., Kyoto (JP)

(72) Inventor: Masayuki IHARA, Kyoto (JP)

(21) Appl. No.: 19/223,746

(22) Filed: May 30, 2025

Related U.S. Application Data
(63) Continuation of application No. PCT/JP2024/002904, filed on Jan. 30, 2024.

(30) Foreign Application Priority Data
Mar. 22, 2023 (JP) 2023-045732

(51) Int. Cl. H01M 4/583; H01M 4/02; H01M 10/0525; H01M 10/0568

(52) U.S. Cl. CPC H01M 4/583; H01M 10/0525; H01M 10/0568; H01M 2004/021; H01M 2004/027

(57) ABSTRACT

Provided is a secondary battery. The secondary battery includes a positive electrode, a negative electrode, and an electrolytic solution. The negative electrode includes a negative electrode active material layer and a negative electrode film that covers a surface of the negative electrode active material layer. The negative electrode film includes nitrogen and boron as constituent elements. The negative electrode active material layer includes a carbon material. The negative electrode active material layer has a thickness of greater than or equal to 30 μm and less than or equal to 100 μm. The negative electrode active material layer has a volume density of greater than or equal to 1.4 g/cm³ and less than or equal to 2 g/cm³. Based on a surface analysis of the negative electrode by X-ray photoelectron spectroscopy, an N1s spectrum derived from nitrogen and a B1s spectrum derived from boron are detectable. The N1s spectrum has a peak position within a range of greater than or equal to 395 eV and less than or equal to 405 eV. The B1s spectrum has a peak position within a range of greater than or equal to 188 eV and less than or equal to 198 eV.

### CROSS REFERENCE TO RELATED APPLICATIONS

The present application is a continuation of International Patent Application No. PCT/JP2024/002904, filed on Jan. 30, 2024, which claims priority to Japanese Patent Application No. 2023-045732, filed on Mar. 22, 2023, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and a liquid electrolyte (an electrolytic solution). A configuration of the secondary battery has been considered in various ways.

Specifically, a gel electrolyte including an electrolytic solution and a polymer compound is used.

### SUMMARY

The present technology relates to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide a secondary battery that makes it possible to achieve a superior battery characteristic.

A secondary battery according to an embodiment of the present technology includes a positive electrode, a negative electrode, and an electrolytic solution. The negative electrode includes a negative electrode active material layer and a negative electrode film that covers a surface of the negative electrode active material layer. The negative electrode film includes nitrogen and boron as constituent elements. The negative electrode active material layer includes a carbon material. The negative electrode active material layer has a thickness of greater than or equal to 30 μm and less than or equal to 100 μm. The negative electrode active material layer has a volume density of greater than or equal to 1.4 g/cm³ and less than or equal to 2 g/cm³. Based on a surface analysis of the negative electrode by X-ray photoelectron spectroscopy, an N1s spectrum derived from nitrogen and a B1s spectrum derived from boron are detectable. The N1s spectrum has a peak position within a range of greater than or equal to 395 eV and less than or equal to 405 eV The B1s spectrum has a peak position within a range of greater than or equal to 188 eV and less than or equal to 198 eV.

Here, the “peak position” of the “N1s spectrum” refers to a position at which a spectrum intensity of the N1s spectrum becomes maximum, and such a position is represented by a binding energy (eV). The “peak position” of the “B1s spectrum” refers to a position at which a spectrum intensity of the B1s spectrum becomes maximum, and such a position is represented by the binding energy (eV). Details of each of the peak position of the N1s spectrum and the peak position of the B1s spectrum will be described later.

According to the secondary battery of an embodiment of the present technology: the negative electrode includes the negative electrode active material layer and the negative electrode film; the negative electrode film includes nitrogen and boron as constituent elements; the negative electrode active material layer includes the carbon material; the thickness of the negative electrode active material layer is greater than or equal to 30 μm and less than or equal to 100 μm; the volume density of the negative electrode active material layer is greater than or equal to 1.4 g/cm³ and less than or equal to 2 g/cm³; based on the surface analysis of the negative electrode by the X-ray photoelectron spectroscopy, the N1s spectrum and the B1s spectrum are detectable; the peak position of the N1s spectrum is within the range of greater than or equal to 395 eV and less than or equal to 405 eV; and the peak position of the B1s spectrum is within the range of greater than or equal to 188 eV and less than or equal to 198 eV. This makes it possible to achieve a superior battery characteristic.

Note that effects of the present technology are not necessarily limited to those described above and may include any of a series of effects described below in relation to the present technology.

### BRIEF DESCRIPTION OF THE FIGURES

FIG. 1 is a perspective diagram illustrating a configuration of a secondary battery according to an embodiment of the present technology.

FIG. 2 is a sectional diagram illustrating a configuration of a battery device illustrated in FIG. 1.

FIG. 3 is a plan diagram illustrating respective configurations of a positive electrode and a negative electrode illustrated in FIG. 2.

FIG. 4 is a block diagram illustrating a configuration of an application example of the secondary battery.

### DETAILED DESCRIPTION

The present technology is described below in further detail including with reference to the drawings according to an embodiment.

A description is given first of a secondary battery according to an embodiment of the present technology.

The secondary battery to be described here is a secondary battery in which a battery capacity is obtained through insertion and extraction of an electrode reactant, and includes a positive electrode, a negative electrode, and an electrolytic solution.

A charge capacity of the negative electrode is preferably greater than a discharge capacity of the positive electrode. In other words, an electrochemical capacity per unit area of the negative electrode is preferably greater than an electrochemical capacity per unit area of the positive electrode. This is to suppress precipitation of the electrode reactant on a surface of the negative electrode during charging.

Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

The following description deals with an example case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

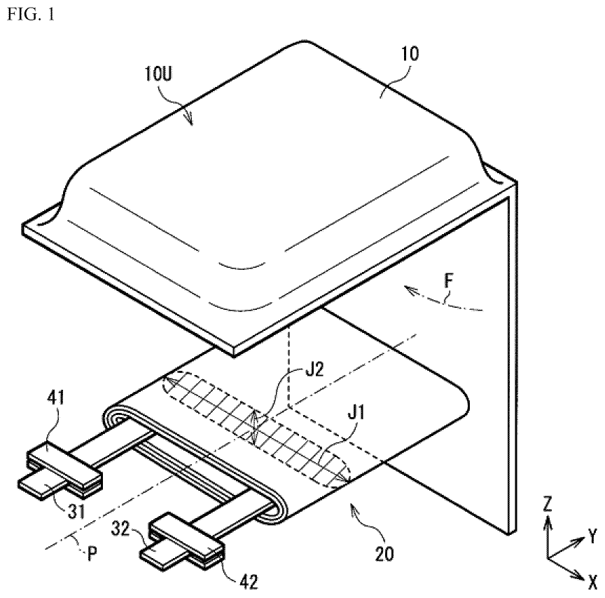

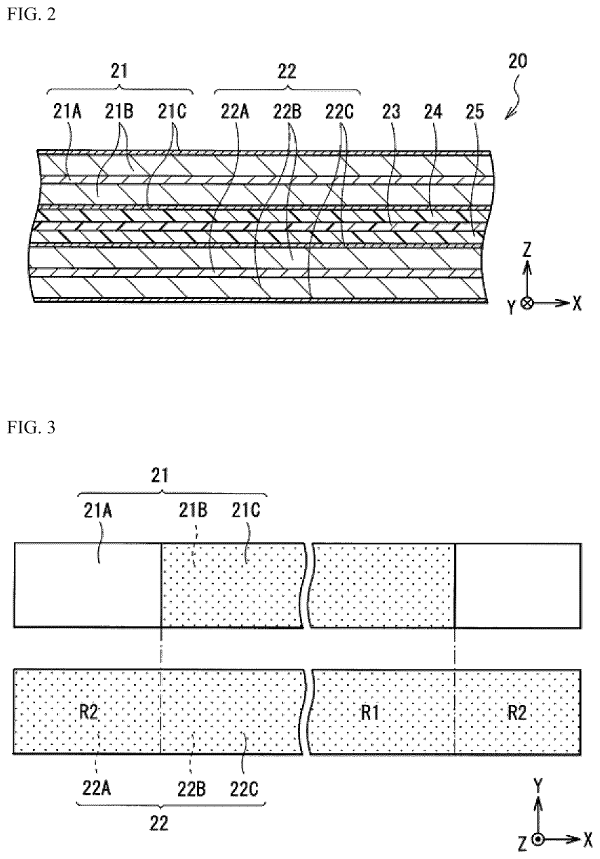

FIG. 1 illustrates a perspective configuration of the secondary battery. FIG. 2 illustrates a sectional configuration of a battery device 20 illustrated in FIG. 1. FIG. 3 illustrates a plan configuration of each of a positive electrode 21 and a negative electrode 22 illustrated in FIG. 2.

Note that FIG. 1 illustrates a state in which an outer package film 10 and the battery device 20 are separated from each other, and indicates a section of the battery device 20 along an XZ plane by a dashed line. FIG. 2 illustrates only a part of the battery device 20. FIG. 3 illustrates a state in which each of the positive electrode 21 and the negative electrode 22 is unwound.

As illustrated in FIGS. 1 to 3, the secondary battery includes the outer package film 10, the battery device 20, a positive electrode lead 31, a negative electrode lead 32, and sealing films 41 and 42.

The secondary battery described here includes the outer package film 10 having flexibility or softness as an outer package member to contain the battery device 20 inside, as described above. Accordingly, the secondary battery illustrated in FIGS. 1 to 3 is a secondary battery of what is called a laminated-film type.

As illustrated in FIG. 1, the outer package film 10 has a pouch-shaped structure that is sealed in a state in which the battery device 20 is contained inside the outer package film 10. The outer package film 10 thus contains the positive electrode 21, the negative electrode 22, and a separator 23 that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state in which the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The battery device 20 is contained inside the outer package film 10. The battery device 20 is what is called a power generation device, and includes, as illustrated in FIGS. 1 to 3, the positive electrode 21, the negative electrode 22, and the separator 23.

Here, the battery device 20 is what is called a wound electrode body. Therefore, the positive electrode 21 and the negative electrode 22 are wound about a winding axis P, being opposed to each other with the separator 23 interposed therebetween. As illustrated in FIG. 1, the winding axis P is a virtual axis extending in a Y-axis direction.

The battery device 20 is not particularly limited in three-dimensional shape. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIGS. 2 and 3, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B includes any one or more of positive electrode active materials which lithium is to be inserted into and extracted from. Note that the positive electrode active material layer 21B may further include any one or more of other materials. Examples of the other materials include a positive electrode binder and a positive electrode conductor. A method of forming the positive electrode active material layer 21B is not particularly limited, and is specifically a method such as a coating method.

Here, the positive electrode active material layer 21B is provided on each of the two opposed surfaces of the positive electrode current collector 21A. However, the positive electrode active material layer 21B may be provided only on one of the two opposed surfaces of the positive electrode current collector 21A on a side where the positive electrode 21 is opposed to the negative electrode 22.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically, for example, an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, and LiMn₂O₄. Specific examples of the phosphoric acid compound include LiFePO₄, LiMnPO₄, and LiFe_{0.5}Mn_{0.5}PO₄.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

Note that the positive electrode 21 may further include a positive electrode film 21C. The positive electrode film 21C is provided on a surface of the positive electrode active material layer 21B, and therefore covers the surface of the positive electrode active material layer 21B.

Here, the positive electrode film 21C covers all of the surface of the positive electrode active material layer 21B. However, the positive electrode film 21C may cover only a part of the surface of the positive electrode active material layer 21B. In this case, multiple positive electrode films 21C may cover the surface of the positive electrode active material layer 21B at respective locations separate from each other.

As will be described later, the positive electrode film 21C is formed on the surface of the positive electrode active material layer 21B through a stabilization process (a first charge and discharge process) of the secondary battery after being assembled in a process of manufacturing the secondary battery. The positive electrode film 21C includes nitrogen and boron as constituent elements. Note that the positive electrode film 21C is not particularly limited in composition, as long as the positive electrode film 21C includes nitrogen and boron as constituent elements.

Here, as will be described later, the electrolytic solution includes nitrogen-boron-containing lithium as an electrolyte salt, and the nitrogen-boron-containing lithium includes nitrogen and boron as constituent elements. Accordingly, the nitrogen-boron-containing lithium included in the electrolytic solution decomposes and reacts upon the stabilization process of the secondary battery after being assembled. The positive electrode film 21C is thus formed on the surface of the positive electrode active material layer 21B.

Accordingly, the positive electrode film 21C includes, as constituent elements, nitrogen and boron derived from the nitrogen-boron-containing lithium. In other words, the nitrogen-boron-containing lithium serves as a source of nitrogen and boron to be included as constituent elements in the positive electrode film 21C. Details of the nitrogen-boron-containing lithium will be described later.

In the secondary battery, predetermined conditions are preferably satisfied in relation to physical properties of the positive electrode 21 (the positive electrode film 21C), in order to improve a battery characteristic. Details of the physical properties of the positive electrode 21 will be described later.

Here, as illustrated in FIG. 3, the positive electrode active material layer 21B is provided on a part of the surface of the positive electrode current collector 21A. More specifically, the positive electrode active material layer 21B is provided in a middle region in a longitudinal direction (a right-left direction in FIG. 3) of the positive electrode current collector 21A. Accordingly, when the positive electrode 21 includes the positive electrode film 21C, the positive electrode film 21C is provided in the middle region in the longitudinal direction of the positive electrode current collector 21A, as with the positive electrode active material layer 21B. Note that in FIG. 3, the positive electrode active material layer 21B and the positive electrode film 21C are shaded.

The negative electrode 22 includes, as illustrated in FIGS. 2 and 3, a negative electrode current collector 22A, a negative electrode active material layer 22B, and a negative electrode film 22C.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

The negative electrode active material layer 22B includes a negative electrode active material which lithium is to be inserted into and extracted from. Note that the negative electrode active material layer 22B may further include any one or more of other materials. Examples of the other materials include a negative electrode binder and a negative electrode conductor. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

Here, the negative electrode active material layer 22B is provided on each of the two opposed surfaces of the negative electrode current collector 22A. Note that the negative electrode active material layer 22B may be provided only on one of the two opposed surfaces of the negative electrode current collector 22A on a side where the negative electrode 22 is opposed to the positive electrode 21.

Specifically, the negative electrode active material includes any one or more of carbon materials. One reason for this is that a high energy density is stably obtainable owing to a crystal structure of the carbon material that does not easily change upon insertion and extraction of lithium. Another reason is that the carbon material also serves as the negative electrode conductor.

The carbon material is not particularly limited in kind, and specific examples thereof include graphitizable carbon, non-graphitizable carbon, and graphite. The graphite may include natural graphite, artificial graphite, or both. The carbon material is not particularly limited in spacing S of a (002) plane measured by X-ray diffractometry. Specific examples of the X-ray diffractometry include wide-angle X-ray diffractometry.

In particular, the carbon material preferably includes graphite, and the spacing S of the (002) plane measured by the X-ray diffractometry is preferably 0.3372 nm or less. One reason for this is that this increases each of a charge capacity and a discharge capacity.

Note that the carbon material may include any one or more of pyrolytic carbons, cokes, glassy carbon fibers, an organic polymer compound fired body, activated carbon, carbon blacks, and the like, for example. The cokes include any one or more of pitch coke, needle coke, petroleum coke, and the like, for example. The organic polymer compound fired body is a resultant of firing or carbonizing a polymer compound at a suitable temperature. Specific examples of the polymer compound include any one or more of a phenol resin, a furan resin, and the like. Other than the above, the carbon material may be low-crystalline carbon heat-treated at about 1000° C. or lower, or may be amorphous carbon heat-treated in a similar manner. The carbon material is not particularly limited in shape, and specifically includes any one or more of a fibrous shape, a spherical shape, a granular shape, or a flaky shape.

Here, the negative electrode active material layer 22B has a thickness T (μm) and a volume density V (g/cm³). Each of the thickness T and the volume density V is made appropriate with respect to physical properties of the negative electrode 22 (the negative electrode film 22C) to be described later. The thickness T described here is a dimension of the negative electrode active material layer 22B in a direction (the Z-axis direction) in which the positive electrode 21 and the negative electrode 22 are opposed to each other with the separator 23 interposed therebetween. More specifically, the thickness T is a thickness of one negative electrode active material layer 22B provided on one of the two opposed surfaces of the negative electrode current collector 22A.

Specifically, the thickness T is within a range from 30 μm to 100 μm both inclusive, and the volume density V is within a range from 1.4 g/cm³ to 2 g/cm³ both inclusive. One reason for this is that when the negative electrode active material layer 22B includes the carbon material, each of the thickness T and the volume density V is made appropriate, which improves chemical stability of the electrolytic solution while securing the energy density.

More specifically, when the thickness T is within the above-described range, if the volume density V is less than 1.4 g/cm³, the energy density decreases. Further, when the thickness T is within the above-described range, if the volume density V is greater than 2 g/cm³, insertion and extraction efficiency of lithium ions decreases, and impregnatability of the negative electrode active material layer 22B with the electrolytic solution decreases. In contrast, when the thickness T is within the above-described range, if the volume density V is within the range from 1.4 g/cm³ to 2 g/cm³ both inclusive, the energy density increases, the insertion and extraction efficiency of the lithium ion improves, and the impregnatability of the negative electrode active material layer 22B with the electrolytic solution improves.

A procedure for calculating each of the thickness T and the volume density V is as described below.

To calculate the thickness T, first, the secondary battery is disassembled to thereby take out the negative electrode 22. Thereafter, the negative electrode 22 is cut in a thickness direction (the Z-axis direction) by means of a cutting tool such as a microtome to thereby expose a section of the negative electrode 22.

Thereafter, the section (the negative electrode active material layer 22B) of the negative electrode 22 is observed by means of an electron microscope to thereby obtain an observation result (an electron micrograph). As the electron microscope, a scanning electron microscope (SEM), a transmission electron microscope (TEM), or both may be used. An observation magnification may be set as desired.

Thereafter, the thickness T (μm) of the negative electrode active material layer 22B is measured based on the electron micrograph. In this case, the thickness T is measured at each of ten locations different from each other to thereby obtain ten thicknesses T. Lastly, an average value of the ten thicknesses T is calculated.

To calculate the volume density V, first, the secondary battery is disassembled to thereby take out the negative electrode 22. Thereafter, the negative electrode 22 is so cut by means of a cutting tool such as the microtome that the negative electrode 22 has a predetermined length L (mm) and a predetermined width W (mm). The length L is a dimension of the negative electrode 22 in the X-axis direction, and the width W is a dimension of the negative electrode 22 in the Y-axis direction. In addition, the thickness T (μm) of the negative electrode active material layer 22B is calculated by the procedure described above.

Thereafter, a weight M1 (g) of the negative electrode 22 after being cut is measured. Thereafter, with use of the negative electrode 22 after being cut, the negative electrode current collector 22A is peeled off from the negative electrode active material layer 22B to thereby obtain the negative electrode current collector 22A. Thereafter, a weight M2 (g) of the obtained negative electrode current collector 22A is measured, following which a weight M3 (g) of the negative electrode active material layer 22B is calculated by subtracting the weight M2 from the weight M1. Lastly, the volume density V is calculated based on the length L, the width W, the thickness T, and the weight M3.

Note that when the negative electrode current collector 22A is obtained from the negative electrode 22 including the negative electrode binder, the negative electrode active material layer 22B may be dissolved and removed from the negative electrode 22 with use of an organic solvent such as dimethyl carbonate, instead of peeling off the negative electrode current collector 22A from the negative electrode active material layer 22B. In this case, because the negative electrode binder in the negative electrode active material layer 22B is dissolved by the organic solvent, the materials including, without limitation, the negative electrode active material are removed from the negative electrode current collector 22A together with the negative electrode binder. The negative electrode current collector 22A is thus obtained from the negative electrode 22.

Note that the negative electrode active material may further include any one or more of metal-based materials. One reason for this is that a high energy density is obtainable.

The term “metal-based material” is a generic term for materials each including, as one or more constituent elements, any one or more elements among metal elements and metalloid elements that are each able to form an alloy with lithium. Specific examples of such metal elements and metalloid elements include silicon and tin. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Details of the negative electrode binder are similar to those of the positive electrode binder. Details of the negative electrode conductor are similar to those of the positive electrode conductor.

The negative electrode film 22C is provided on a surface of the negative electrode active material layer 22B, and therefore covers the surface of the negative electrode active material layer 22B.

Here, the negative electrode film 22C covers all of the surface of the negative electrode active material layer 22B. However, the negative electrode film 22C may cover only a part of the surface of the negative electrode active material layer 22B. In this case, multiple negative electrode films 22C may cover the surface of the negative electrode active material layer 22B at respective locations separate from each other.

As with the positive electrode film 21C, the negative electrode film 22C is formed on the surface of the negative electrode active material layer 22B through the stabilization process of the secondary battery after being assembled. The negative electrode film 22C includes nitrogen and boron as constituent elements. Note that the negative electrode film 22C is not particularly limited in composition, as long as the negative electrode film 22C includes nitrogen and boron as constituent elements.

Here, the electrolytic solution includes the nitrogen-boron-containing lithium as the electrolyte salt, as will be described later. Details of the nitrogen-boron-containing lithium are as described above. Accordingly, the nitrogen-boron-containing lithium included in the electrolytic solution decomposes and reacts upon the stabilization process of the secondary battery after being assembled. The negative electrode film 22C is thus formed on the surface of the negative electrode active material layer 22B.

Accordingly, as with the positive electrode film 21C, the negative electrode film 22C includes, as constituent elements, nitrogen and boron derived from the nitrogen-boron-containing lithium. In other words, the nitrogen-boron-containing lithium serves as a source of nitrogen and boron to be included as constituent elements in the negative electrode film 22C. Details of the nitrogen-boron-containing lithium will be described later.

In the secondary battery, predetermined conditions are satisfied in relation to the physical properties of the negative electrode 22 (the negative electrode film 22C), in order to improve the battery characteristic. Details of the physical properties of the negative electrode 22 will be described later.

Here, as illustrated in FIG. 3, the negative electrode active material layer 22B is provided on all of the surface of the negative electrode current collector 22A. More specifically, the negative electrode active material layer 22B is provided in the entire region in a longitudinal direction (the right-left direction in FIG. 3) of the negative electrode current collector 22A. Accordingly, the negative electrode film 22C is provided in the entire region in the longitudinal direction of the negative electrode current collector 22A, as with the negative electrode active material layer 22B. Note that in FIG. 3, the negative electrode active material layer 22B and the negative electrode film 22C are shaded.

The negative electrode 22 thus includes one opposed part R1 and two non-opposed parts R2. The opposed part R1 is a part in which the negative electrode active material layer 22B is opposed to the positive electrode active material layer 21B, and is thus to be involved in charging and discharging reactions. In contrast, the non-opposed parts R2 are each a part in which the negative electrode active material layer 22B is not opposed to the positive electrode active material layer 21B, and are thus not to be substantially involved in the charging and discharging reactions. Here, the opposed part R1 is disposed between the two non-opposed parts R2.

### [Separator]

The separator 23 is an insulating porous film interposed between the positive electrode 21 and the negative electrode 22 as illustrated in FIG. 2, and allows lithium to pass therethrough in an ionic state while preventing occurrence of a short circuit to be caused by contact between the positive electrode 21 and the negative electrode 22. The separator 23 includes a polymer compound such as polyethylene.

The electrolytic solution includes a solvent and an electrolyte salt. The positive electrode 21, the negative electrode 22, and the separator 23 are each impregnated with the electrolytic solution.

The solvent includes any one or more of non-aqueous solvents (organic solvents), and the electrolytic solution including the one or more non-aqueous solvents is what is called a non-aqueous electrolytic solution. One reason why the solvent includes the non-aqueous solvent(s) is that a dissociation property of the electrolyte salt and mobility of ions improve.

The non-aqueous solvent includes, for example, an ester or an ether, more specifically, any one or more of a carbonic-acid-ester-based compound, a carboxylic-acid-ester-based compound, or a lactone-based compound.

The carbonic-acid-ester-based compound is a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate. The carboxylic-acid-ester-based compound is, for example, a chain carboxylic acid ester. Specific examples of the chain carboxylic acid ester include ethyl acetate, ethyl propionate, propyl propionate, and ethyl trimethylacetate. The lactone-based compound is, for example, a lactone. Specific examples of the lactone include γ-butyrolactone and γ-valerolactone. Note that the ether may be, for example, 1,2-dimethoxyethane, tetrahydrofuran, 1,3-dioxolane, or 1,4-dioxane.

The electrolytic solution may further include any one or more of other solvents. Specific examples of the other solvents include an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, and an isocyanate compound. One reason for this is that electrochemical stability of the electrolytic solution improves.

The unsaturated cyclic carbonic acid ester is a cyclic carbonic acid ester having an unsaturated carbon bond (a carbon-carbon double bond). The number of unsaturated carbon bonds is not particularly limited, and may be only one, or two or more. Specific examples of the unsaturated cyclic carbonic acid ester include vinylene carbonate, vinyl ethylene carbonate, and methylene ethylene carbonate.

The fluorinated cyclic carbonic acid ester is a cyclic carbonic acid ester including fluorine as a constituent element. That is, the fluorinated cyclic carbonic acid ester is a compound corresponding to a cyclic carbonic acid ester in which one or more hydrogen groups are substituted with one or more fluorine groups. Specific examples of the fluorinated cyclic carbonic acid ester include monofluoroethylene carbonate and difluoroethylene carbonate.

The sulfonic acid ester is, for example, a cyclic monosulfonic acid ester, a cyclic disulfonic acid ester, a chain monosulfonic acid ester, or a chain disulfonic acid ester. Specific examples of the cyclic monosulfonic acid ester include 1,3-propane sultone, 1-propene-1,3-sultone, 1,4-butane sultone, 2,4-butane sultone, and methanesulfonate propargyl ester. Specific examples of the cyclic disulfonic acid ester include cyclodisone.

Specific examples of the dicarboxylic acid anhydride include succinic anhydride, glutaric anhydride, and maleic anhydride.

Specific examples of the disulfonic acid anhydride include ethanedisulfonic anhydride and propanedisulfonic anhydride.

Specific examples of the sulfuric acid ester include ethylene sulfate (1,3,2-dioxathiolan 2,2-dioxide).

The nitrile compound is a compound including one or more cyano groups (—CN). Specific examples of the nitrile compound include octanenitrile, benzonitrile, phthalonitrile, succinonitrile, glutaronitrile, adiponitrile, cebaconitrile, 1,3,6-hexanetricarbonitrile, 3,3′-oxydipropionitrile, 3-butoxypropionitrile, ethylene glycol bispropionitrile ether, 1,2,2,3-tetracyanopropane, tetracyanopropane, fumaronitrile, 7,7,8,8-tetracyanoquinodimethane, cyclopentanecarbonitrile, 1,3,5-cyclohexanetricarbonitrile, and 1,3-bis(dicyanomethylidene)indane.

The isocyanate compound is a compound including one or more isocyanate groups (—NCO). Specific examples of the isocyanate compound include hexamethylene diisocyanate.

The electrolyte salt includes any one or more of light metal salts. Here, because the electrode reactant is lithium as described above, the electrolyte salt includes any one or more of lithium salts.

The lithium salt includes a cation (a lithium ion) and an anion. The anion is not particularly limited in kind, and may be chosen as desired.

In particular, the lithium salt preferably includes an anion represented by Formula (1). Hereinafter, the anion represented by Formula (1) is referred to as a nitrogen-boron-containing anion, and the lithium salt including the nitrogen-boron-containing anion is referred to as nitrogen-boron-containing lithium.

B(R1)(R2)(R3)CN⁻ (1)
where:
each of R1, R2, and R3 is any one of a fluorine group, a cyano group, an alkyl group, a fluorinated alkyl group, a fluorinated ester group, or a fluorinated alkoxy group; and
at least one of R1, R2, or R3 is any one of the fluorine group, the fluorinated alkyl group, the fluorinated ester group, or the fluorinated alkoxy group.

The nitrogen-boron-containing anion is an anion including nitrogen and boron as constituent elements. One reason why the electrolyte salt includes the nitrogen-boron-containing lithium (the nitrogen-boron-containing anion) is that the nitrogen-boron-containing lithium serves as the source of nitrogen and boron upon the stabilization process of the secondary battery after being assembled as described above, and thus allows for easy formation of the negative electrode film 22C including nitrogen and boron as constituent elements. Note that when the positive electrode 21 includes the positive electrode film 21C, this also allows for easy formation of the positive electrode film 21C.

Each of R1 to R3 is not particularly limited as long as each of R1 to R3 is any one of a fluorine group, a cyano group, an alkyl group, a fluorinated alkyl group, a fluorinated ester group, or a fluorinated alkoxy group, as described above. Note that, however, two or more of R1 to R3 are each a group including fluorine as a constituent element, more specifically, any one of the fluorine group, the fluorinated alkyl group, the fluorinated ester group, or the fluorinated alkoxy group.

The alkyl group is not particularly limited in carbon number, and specific examples thereof include a methyl group, an ethyl group, a propyl group, and a butyl group. Note that the alkyl group may have a straight-chain structure, or may have a branched structure.

The fluorinated alkyl group is a group corresponding to an alkyl group in which one or more hydrogen groups are substituted with one or more fluorine groups. Specific examples of the fluorinated alkyl group include a perfluoromethyl group (—CF₃), a perfluoroethyl group (—C₂F₅), a perfluoropropyl group (—C₃F₇), and a perfluorobutyl group (—C₄F₉).

The fluorinated ester group is represented by Formula (2). Details of the fluorinated alkyl group are as described above. Specific examples of the fluorinated aryl group include a perfluorophenyl group (—C₆F₅) and a perfluoronaphthyl group (—C₁₀F₇).

—C(═O)—O—R4 (2)

where R4 is either a fluorinated alkyl group or a fluorinated aryl group.

Specific examples of the fluorinated ester group include —C(═O)—O—CF₃, —C(═O)—O—C₂F₅, and —C(═O)—O—C₆F₅.

The fluorinated alkoxy group is represented by Formula (3). Details of each of the alkyl group, the fluorinated alkyl group, and the fluorinated aryl group are as described above. Specific examples of the aryl group include a phenyl group (—C₆H₅) and a naphthyl group (—C₁₀H₇).

—O—C(R5)(R6)(R7) (3)
where:
each of R5, R6, and R7 is any one of a hydrogen group, an alkyl group, an aryl group, a fluorinated alkyl group, or a fluorinated aryl group; and
at least one of R5, R6, or R7 is either the fluorinated alkyl group or the fluorinated aryl group.

Each of R5 to R7 is not particularly limited as long as each of R5 to R7 is any one of a hydrogen group, an alkyl group, an aryl group, a fluorinated alkyl group, or a fluorinated aryl group, as described above. Note that, however, one or more of R5 to R7 are each a group including fluorine as a constituent element, more specifically, either the fluorinated alkoxy group or the fluorinated aryl group.

Specific examples of the fluorinated alkoxy group include —O—CH₂(CF₃), —O—CH₂(C₂F₅), —O—CH(CF₃)₂, —O—CH(C₂F₅)₂, —O—C(CF₃)₃, —O—C(C₂F₅)₃, —O—C(CH₃)(CF₃)₂, —O—C(CH₃)(C₂F₅)₂, —O—C(C₆H₅)(CF₃)₂, and —O—C(C₆H₅)(C₂F₅)₂.

Specific examples of the nitrogen-boron-containing anion include BF₃CN⁻, BF₂(CH₃)CN⁻, BF₂(CF₃)CN⁻, BF₂(CN)₂⁻, BF(CF₃)₂CN⁻, BF(C₂F₅)₂CN⁻, BF(CN)₃⁻, BF(CF₃)(CN)₂⁻, BF(C₂F₅)(CN)₂⁻, B(CF₃)₃CN⁻, B(CF₃)₂(CN)₂⁻, B(C₂F₅)₃CN⁻, B(C₂F₅)₂(CN)₂⁻, B(CF₃)(CN)₃⁻, B(CF₃)₂(CN)₂⁻, B(C₂F₅)(CN)₃⁻, and B(C₂F₅)₂(CN)₂⁻.

Specific examples of the nitrogen-boron-containing lithium therefore include LiBF₃CN, LiBF₂(CH₃)CN, LiBF₂(CF₃)CN, LiBF₂(CN)₂, LiBF(CF₃)₂CN, LiBF(C₂F₅)₂CN, LiBF(CN)₃, LiBF(CF₃)(CN)₂, LiBF(C₂F₅)(CN)₂, LiB(CF₃)₃CN, LiB(CF₃)₂(CN)₂, LiB(C₂F₅)₃CN, LiB(C₂F₅)₂(CN)₂, LiB(CF₃)(CN)₃, LiB(CF₃)₂(CN)₂, LiB(C₂F₅)(CN)₃, and LiB(C₂F₅)₂(CN)₂.

Note that although not specifically listed here, a specific example of the nitrogen-boron-containing anion may be an anion in which one or more of R1 to R3 described above are each a fluorinated ester group, or may be an anion in which one or more of R1 to R3 are each a fluorinated alkoxy group.

Accordingly, although not specifically listed here, a specific example of the nitrogen-boron-containing lithium may be a lithium salt in which one or more of R1 to R3 described above are each a fluorinated ester group, or may be a lithium salt in which one or more of R1 to R3 are each a fluorinated alkoxy group.

A content of the electrolyte salt is not particularly limited, and is preferably within a range from 0.5 mol/kg to 2 mol/kg both inclusive with respect to the solvent, in particular. One reason for this is that high ion conductivity is obtainable.

The electrolytic solution may further include any one or more of other electrolyte salts. Specific examples of the other electrolyte salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). One reason for this is that a high battery capacity is obtainable.

In particular, the one or more other electrolyte salts preferably include any one or more of lithium hexafluorophosphate, lithium tetrafluoroborate, lithium bis(fluorosulfonyl)imide, lithium bis(oxalato)borate, or lithium difluorophosphate. One reason for this is that migration velocity of the cation sufficiently improves in the vicinity of the surface of each of the positive electrode 21 and the negative electrode 22, and the migration velocity of the cation sufficiently improves also in the electrolytic solution.

A method of analyzing the electrolytic solution is not particularly limited, and specifically includes any one or more of methods including, without limitation, inductively coupled plasma (ICP) optical emission spectroscopy, nuclear magnetic resonance (NMR) spectroscopy, and gas chromatography mass spectrometry (GC-MS).

To analyze the electrolytic solution, the secondary battery is disassembled to thereby take out the electrolytic solution, following which the electrolytic solution is analyzed. This allows for identification of a kind of the electrolyte salt, and also allows for identification of the content of the electrolyte salt in the electrolytic solution.

As illustrated in FIGS. 1 and 2, the positive electrode lead 31 is a positive electrode wiring coupled to the positive electrode current collector 21A of the positive electrode 21, and is led to an outside of the outer package film 10. The positive electrode lead 31 includes an electrically conductive material such as a metal material. Specific examples of the electrically conductive material include aluminum. The positive electrode lead 31 has any one of shapes including, without limitation, a thin plate shape and a meshed shape.

As illustrated in FIGS. 1 and 2, the negative electrode lead 32 is a negative electrode wiring coupled to the negative electrode current collector 22A of the negative electrode 22, and is led to the outside of the outer package film 10. Here, the negative electrode lead 32 is led in a direction similar to a direction in which the positive electrode lead 31 is led. The negative electrode lead 32 includes an electrically conductive material such as a metal material. Specific examples of the electrically conductive material include copper. Note that details of a shape of the negative electrode lead 32 are similar to those of the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

The sealing film 42 has a configuration similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

In the secondary battery, the predetermined conditions (physical property conditions) are satisfied in relation to the physical properties of the negative electrode 22 (the negative electrode film 22C), in order to improve the battery characteristic, as described above.

Specifically, the negative electrode 22 includes the negative electrode film 22C covering the surface of the negative electrode active material layer 22B, and the negative electrode film 22C includes nitrogen and boron as constituent elements, as described above. Therefore, when an analysis (an elemental analysis) is performed on the surface (the negative electrode film 22C) of the negative electrode 22 by the X-ray photoelectron spectroscopy, a photoelectron spectrum is obtained, where a horizontal axis represents a binding energy (eV) and a vertical axis represents a spectrum intensity. The photoelectron spectrum includes two kinds of photoelectron spectra derived from the constituent elements of the positive electrode film 21C. The two kinds of photoelectron spectra are an N1s spectrum derived from nitrogen and a B1s spectrum derived from boron.

In this case, the physical property conditions are satisfied in relation to the physical properties of the negative electrode 22, as described above. Specifically, the N1s spectrum has a peak position N within a range from 395 eV to 405 eV both inclusive, and the B is spectrum has a peak position B within a range from 188 eV to 198 eV both inclusive.

Here, the “peak position N” of the “N1s spectrum” refers to a position at which a spectrum intensity of the N1s spectrum becomes maximum, and such a position is represented by the binding energy (eV), as described above. Accordingly, the wording “the peak position N is within the range from 395 eV to 405 eV both inclusive” means that the spectrum intensity of the N1s spectrum becomes maximum within the range in which the binding energy is from 395 eV to 405 eV both inclusive.

Similarly, the “peak position B” of the “B1s spectrum” refers to a position at which a spectrum intensity of the B1s spectrum becomes maximum, and such a position is represented by the binding energy (eV), as described above. Accordingly, the wording “the peak position B is within the range from 188 eV to 198 eV both inclusive” means that the spectrum intensity of the B1s spectrum becomes maximum within the range in which the binding energy is from 188 eV to 198 eV both inclusive.

One reason why the physical property conditions are satisfied in relation to the physical properties of the negative electrode 22 is that this allows an electrochemical state of the negative electrode film 22C to be appropriate, and thus suppresses degradation of the battery characteristic.

More specifically, the negative electrode active material layer 22B includes the negative electrode active material that is highly reactive, and when the negative electrode active material is activated upon charging and discharging, the negative electrode active material easily reacts with the electrolytic solution. When the negative electrode active material reacts with the electrolytic solution, a decomposition reaction of the electrolytic solution is promoted, which causes the battery characteristic to be easily deteriorated.

However, the negative electrode film 22C is provided on the surface of the negative electrode active material layer 22B, and when the physical property conditions are satisfied in relation to the physical properties of the negative electrode 22 (the negative electrode film 22C), the electrochemical state of the negative electrode film 22C is made appropriate. Accordingly, the surface of the negative electrode active material layer 22B is protected by using the negative electrode film 22C that is electrochemically stable. This suppresses the decomposition reaction of the electrolytic solution caused by the reaction between the negative electrode active material and the electrolytic solution. In addition, although the negative electrode film 22C is provided on the surface of the negative electrode active material layer 22B, smooth insertion and extraction of lithium at the negative electrode active material layer 22B (the negative electrode active material) is achieved. Thus, the decomposition reaction of the electrolytic solution is suppressed while smooth insertion and extraction of lithium at the negative electrode active material layer 22B is achieved. This suppresses the degradation of the battery characteristic.

Note that when the positive electrode 21 includes the positive electrode film 21C, the above-described physical property conditions may be similarly satisfied also in relation to the physical properties of the positive electrode 21 (the positive electrode film 21C). Specifically, based on a surface analysis of the positive electrode 21 (the positive electrode film 21C) by the XPS, a peak position N of a N1s spectrum is within a range from 395 eV to 405 eV both inclusive, and a peak position B of a B1s spectrum is within a range from 188 eV to 198 eV both inclusive. Thus, an electrochemical state of the positive electrode film 21C is made appropriate. Accordingly, the decomposition reaction of the electrolytic solution is suppressed while smooth insertion and extraction of lithium at the positive electrode active material layer 21B is achieved. As a result, the degradation of the battery characteristic is suppressed.

To perform the surface analysis of the negative electrode 22, first, the secondary battery is discharged until a voltage reaches 2.5 V, following which the secondary battery is disassembled inside a glove box (in an inert atmosphere) to thereby take out the negative electrode 22. The inert atmosphere is not particularly limited in kind, and is specifically an atmosphere including an inert gas such as an argon gas. Thereafter, the negative electrode 22 is washed with an organic solvent, following which the washed negative electrode 22 is introduced inside an analysis apparatus (an XPS apparatus) without being exposed to the air. The organic solvent is not particularly limited in kind, and is specifically, dimethyl carbonate, for example. Lastly, the negative electrode 22 is analyzed by the XPS apparatus.

As the XPS apparatus, an X-ray photoelectron spectrometer, Quantera SXM, available from ULVAC-PHI Inc. may be used. As the analysis conditions, an incident X-ray is set to a monochromatic AlKα-ray (1486.6 eV), an analysis region (a beam size) is set to 100 amp, and an analysis depth is set to several nanometers.

In this case, an F1s spectrum derived from fluorine is used to perform energy correction on the photoelectron spectrum. Specifically, a position (a binding energy) of a main peak located on the lowest bound energy side of the F1s spectrum is set to 685.1 eV by performing a waveform analysis using commercially available software.

To identify the peak position N, the photoelectron spectrum (the N1s spectrum) is obtained, following which the binding energy at the position at which the spectrum intensity of the N1s spectrum becomes maximum is checked.

To identify the peak position B, the photoelectron spectrum (the B1s spectrum) is obtained, following which the binding energy at the position at which the spectrum intensity of the B1s spectrum becomes maximum is checked.

A procedure for performing the surface analysis of the positive electrode 21 is similar to the procedure for performing the surface analysis of the negative electrode 22 described above, except that the positive electrode 21 is taken out from the secondary battery instead of the negative electrode 22.

Note that to check if the physical property conditions are satisfied in relation to the negative electrode 22, it is preferable to analyze the non-opposed part R2 of the negative electrode 22, as illustrated in FIG. 3. One reason for this is that because the non-opposed part R2 is not substantially involved in the charging and discharging reactions, it is possible to accurately check, with high reproducibility, whether the physical property conditions are satisfied, independently of charging and discharging history (such as whether the secondary battery has been charged and discharged, or the number of times of charging and discharging).

For a similar reason, to check the configuration (the thickness T, the volume density V, and the spacing S) of the negative electrode active material layer 22B, it is preferable to analyze the non-opposed part R2 of the negative electrode 22.

The secondary battery operates as described below in the battery device 20.

Upon charging, lithium is extracted from the positive electrode 21, and the extracted lithium is inserted into the negative electrode 22 via the electrolytic solution. Upon discharging, lithium is extracted from the negative electrode 22, and the extracted lithium is inserted into the positive electrode 21 via the electrolytic solution. Upon each of the discharging and the charging, lithium is inserted and extracted in an ionic state.

To manufacture the secondary battery, the positive electrode 21 and the negative electrode 22 are each fabricated, and the electrolytic solution is prepared, following which the secondary battery is assembled using the positive electrode 21, the negative electrode 22, and the electrolytic solution, and the stabilization process of the assembled secondary battery is performed, according to an example procedure to be described below.

A description is given below of a case where both the positive electrode film 21C and the negative electrode film 22C are formed.

First, the positive electrode active material, the positive electrode binder, and the positive electrode conductor are mixed with each other to thereby obtain a positive electrode mixture. Thereafter, the positive electrode mixture is put into a solvent to thereby prepare a positive electrode mixture slurry in paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Thereafter, the positive electrode active material layers 21B may be compression-molded by, for example, a roll pressing machine. In this case, the positive electrode active material layers 21B may be heated. The positive electrode active material layers 21B may be compression-molded multiple times. Lastly, as will be described later, the secondary battery is assembled, following which the stabilization process is performed using the assembled secondary battery. The positive electrode film 21C is thus formed on the surface of each of the positive electrode active material layers 21B. As a result, the positive electrode 21 is fabricated.

The negative electrode 22 is formed by a procedure similar to the fabrication procedure of the positive electrode 21 described above. Specifically, first, a mixture (a negative electrode mixture) in which the negative electrode active material including the carbon material, the negative electrode binder, and the negative electrode conductor are mixed with each other is put into a solvent to thereby prepare a negative electrode mixture slurry in paste form. Thereafter, the negative electrode mixture slurry is applied on the two opposed surfaces of the negative electrode current collector 22A to thereby form the negative electrode active material layers 22B. Thereafter, the negative electrode active material layers 22B may be compression-molded. Lastly, the secondary battery is assembled, following which the stabilization process is performed using the assembled secondary battery. The negative electrode film 22C is thus formed on the surface of each of the negative electrode active material layers 22B. As a result, the negative electrode 22 is fabricated.

The electrolyte salt is put into the solvent. In this case, the nitrogen-boron-containing lithium may be used as the electrolyte salt, as described above. The electrolyte salt is thereby dispersed or dissolved in the solvent. The electrolytic solution is thus prepared.

First, the positive electrode lead 31 is coupled to the positive electrode current collector 21A of the positive electrode 21 by a joining method such as a welding method, and the negative electrode lead 32 is coupled to the negative electrode current collector 22A of the negative electrode 22 by the joining method such as the welding method.

Thereafter, the positive electrode current collector 21A on which the positive electrode active material layer 21B is formed and the negative electrode current collector 22A on which the negative electrode active material layer 22B is formed are stacked on each other with the separator 23 interposed therebetween, to thereby form a stacked body (not illustrated). Thereafter, the stacked body is wound to thereby fabricate a wound body (not illustrated), following which the wound body is pressed by, for example, a pressing machine to thereby shape the wound body into an elongated shape. The wound body after the shaping has a configuration similar to that of the battery device 20, except that the wound body does not include the positive electrode film 21C and the negative electrode film 22C and that the wound body is not impregnated with the electrolytic solution.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the wound body is sealed in the outer package film 10 having the pouch shape. The secondary battery is thus assembled.

The assembled secondary battery is charged and discharged. Various conditions including, for example, an environment temperature, the number of times of charging and discharging (the number of cycles), and charging and discharging conditions may be set as desired.

The positive electrode film 21C is thereby formed on the surface of the positive electrode active material layer 21B, and the positive electrode 21 is fabricated as a result. In addition, the negative electrode film 22C is thereby formed on the surface of the negative electrode active material layer 22B, and the negative electrode 22 is fabricated as a result. Accordingly, the battery device 20 is fabricated, and the battery device 20 is sealed in the outer package film 10 having the pouch shape. As a result, the secondary battery is completed.

According to the above-described secondary battery, the negative electrode 22 includes the negative electrode active material layer 22B and the negative electrode film 22C, and the negative electrode film 22C includes nitrogen and boron as constituent elements.

The negative electrode active material layer 22B includes the carbon material. In addition, the thickness T of the negative electrode active material layer 22B is within the range from 30 μm to 100 μm both inclusive, and the volume density V of the negative electrode active material layer 22B is within the range from 1.4 g/cm³ to 2 g/cm³ both inclusive.

Based on the surface analysis of the negative electrode 22 (the negative electrode film 22C) by the XPS, the peak position N of the N1s spectrum is within the range from 395 eV to 405 eV both inclusive, and the peak position B of the B1s spectrum is within the range from 188 eV to 198 eV both inclusive.

In this case, a series of kinds of action described below is achieved, as described above.

Firstly, the chemical stability of the electrolytic solution improves while the energy density is secured, because when the negative electrode active material layer 22B includes the carbon material, the thickness T and the volume density V of the negative electrode active material layer 22B are each made appropriate.

Secondly, the electrochemical state of the negative electrode film 22C is made appropriate, because the negative electrode 22 includes the negative electrode film 22C, and the physical property conditions are satisfied in relation to the physical properties (the peak position N and the peak position B) of the negative electrode 22. This suppresses the decomposition reaction of the electrolytic solution while achieving smooth insertion and extraction of lithium at the negative electrode active material layer 22B.

Accordingly, the chemical stability of the electrolytic solution improves while the energy density is secured, and the decomposition reaction of the electrolytic solution is suppressed while smooth insertion and extraction of lithium at the negative electrode active material layer 22B is achieved. It is therefore possible to achieve a superior battery characteristic. In this case, it is possible to achieve a superior battery characteristic even if the secondary battery is used or stored in a severe environment such as a high-temperature environment or a low-temperature environment, in particular.

In particular, the carbon material may include graphite, and the spacing S of the (002) plane of the graphite may be 0.3372 nm or less. This increases each of the charge capacity and the discharge capacity. Accordingly, it is possible to achieve higher effects.

Further, the positive electrode 21 may include the positive electrode active material layer 21B and the positive electrode film 21C, the positive electrode film 21C may include nitrogen and boron as constituent elements, and the physical property conditions may be satisfied also in relation to the positive electrode 21 (the positive electrode film 21C). This further suppresses the decomposition reaction of the electrolytic solution while achieving smooth insertion and extraction of lithium at the positive electrode active material layer 21B. Accordingly, it is possible to achieve higher effects.

Further, the electrolyte salt may include the nitrogen-boron-containing anion. This allows for easy formation of the negative electrode film 22C. Accordingly, it is possible to achieve higher effects. Note that when the positive electrode 21 includes the positive electrode film 21C, the positive electrode film 21C is also formed easily. Accordingly, it is possible to achieve even higher effects.

In this case, the content of the electrolyte salt in the electrolytic solution is within the range from 0.5 mol/kg to 2 mol/kg both inclusive with respect to the solvent. This allows for sufficiently easy formation of the negative electrode film 22C. Accordingly, it is possible to achieve even higher effects. Note that when the positive electrode 21 includes the positive electrode film 21C, the positive electrode film 21C is also formed sufficiently easily. Accordingly, it is possible to achieve markedly high effects.

Further, the electrolytic solution may further include any one or more of the unsaturated cyclic carbonic acid ester, the fluorinated cyclic carbonic acid ester, the sulfonic acid ester, the dicarboxylic acid anhydride, the disulfonic acid anhydride, the sulfuric acid ester, the nitrile compound, or the isocyanate compound. This improves the electrochemical stability of electrolytic solution. Accordingly, it is possible to achieve higher effects.

Further, the electrolytic solution may include any one or more of lithium hexafluorophosphate, lithium tetrafluoroborate, lithium bis(fluorosulfonyl)imide, lithium bis(oxalato)borate, or lithium difluorophosphate. This sufficiently improves the migration velocity of the cation. Accordingly, it is possible to achieve higher effects.

Further, the secondary battery may include a lithium-ion secondary battery. This makes it possible to obtain a sufficient battery capacity stably through insertion and extraction of lithium. Accordingly, it is possible to achieve higher effects.

The configuration of the secondary battery is appropriately modifiable as described below according to an embodiment. Note that any of the following series of modification examples may be combined with each other.

In the secondary battery described above, the electrolyte salt includes the nitrogen-boron-containing lithium, and the negative electrode film 22C therefore includes nitrogen and boron as constituent elements.

However, the secondary battery is not particularly limited in configuration as long as the negative electrode film 22C includes nitrogen and boron as constituent elements. Therefore, the electrolyte salt does not have to include the nitrogen-boron-containing lithium. In this case, if the secondary battery, more specifically, the battery device 20, includes therein a source of nitrogen and boron instead of the nitrogen-boron-containing lithium, the negative electrode film 22C including nitrogen and boron as constituent elements is formed through the stabilization process of the secondary battery after being assembled. The source may be a combination of a compound including nitrogen as a constituent element and a compound including boron as a constituent element, or may be a compound including both nitrogen and boron as constituent elements.

In this case also, the negative electrode film 22C including nitrogen and boron as constituent elements is formed. Therefore, if the physical property conditions are satisfied in relation to the physical properties of the negative electrode 22 (the negative electrode film 22C), it is possible to achieve similar effects.

The above description regarding the negative electrode film 22C similarly applies to the positive electrode film 21C. Specifically, because the secondary battery is not particularly limited in configuration as long as the positive electrode film 21C includes nitrogen and boron as constituent elements, the electrolyte salt does not have to include the nitrogen-boron-containing lithium. In this case also, the positive electrode film 21C including nitrogen and boron as constituent elements is formed. Therefore, if the physical property conditions are satisfied in relation to the physical properties of the positive electrode 21 (the positive electrode film 21C), it is possible to achieve similar effects.

In the above-described process of manufacturing the secondary battery, the negative electrode film 22C is formed after the assembly of the secondary battery by forming the negative electrode film 22C on the surface of the negative electrode active material layer 22B through the stabilization process of the secondary battery after being assembled. However, the negative electrode film 22C may be formed before the assembly of the secondary battery by forming the negative electrode film 22C without using the stabilization process.

Described below is a procedure for fabricating the negative electrode 22 when the negative electrode film 22C is formed before the assembly of the secondary battery without using the stabilization process.

First, the negative electrode active material layer 22B is formed on the surface of the negative electrode current collector 22A by the above-described procedure.

Thereafter, a material to be included in the negative electrode film 22C and a dispersing solvent are mixed with each other to prepare a process solution. The material to be included in the negative electrode film 22C is not particularly limited, as long as the material includes any one or more of compounds each including nitrogen and boron as constituent elements. The dispersing solvent is not particularly limited in kind, and may therefore be an aqueous solvent or an organic solvent.

Note that, to prepare the process solution, a binder may be included in the process solution. Details of the binder are similar to the details of each of the positive electrode binder and the negative electrode binder.

Lastly, the process solution is applied on the surface of the negative electrode active material layer 22B, following which the applied process solution is dried to thereby form the negative electrode film 22C. In this case, instead of applying the process solution on the surface of the negative electrode active material layer 22B, the negative electrode active material layer 22B may be immersed in the process solution, following which the negative electrode active material layer 22B may be taken out of the process solution and dried.

The negative electrode 22 including the negative electrode film 22C is thus fabricated. Therefore, in the process of assembling the secondary battery, the secondary battery is assembled using the fabricated negative electrode 22.

In this case also, the negative electrode film 22C is formed. Therefore, if the physical property conditions are satisfied in relation to the physical properties of the negative electrode 22 (the negative electrode film 22C), the decomposition reaction of the electrolytic solution is suppressed while smooth insertion and extraction of lithium is achieved, and the charging and discharging reaction easily continues to proceed stably. Accordingly, it is possible to achieve similar effects.

Note that the positive electrode film 21C may be formed without using the stabilization process of the secondary battery after being assembled, by a procedure similar to the above-described procedure for forming the negative electrode film 22C. The positive electrode film 21C is thus formed before the assembly of the secondary battery. In this case also, the positive electrode film 21C is formed. Therefore, if the physical property conditions are satisfied in relation to the physical properties of the positive electrode 21 (the positive electrode film 21C), it is possible to achieve similar effects.

As described above, the electrolytic solution may include the other electrolyte salt(s) together with the electrolyte salt including the nitrogen-boron-containing anion.

In particular, the electrolytic solution preferably includes lithium hexafluorophosphate as the other electrolyte salt, and the content of the electrolyte salt in the electrolytic solution is preferably made appropriate in relation to a content of the other electrolyte salt in the electrolytic solution.

Specifically, the electrolyte salt includes the cation and the nitrogen-boron-containing anion. The lithium hexafluorophosphate includes a lithium ion and a hexafluorophosphate ion.

In this case, a sum T (mol/kg) of a content C1 of the cation in the electrolytic solution and a content C2 of the lithium ion in the electrolytic solution is preferably within a range from 0.6 mol/kg to 2.5 mol/kg both inclusive. One reason for this is that the migration velocity of the cation and a migration velocity of the lithium ion sufficiently improve in the vicinity of the surface of each of the positive electrode 21 and the negative electrode 22, and the migration velocity of the cation and the migration velocity of the lithium ion sufficiently improve also in the electrolytic solution.

The “content of the cation in the electrolytic solution” described above refers to the content of the cation with respect to the solvent, and the “content of the lithium ion in the electrolytic solution” described above refers to the content of the lithium ion with respect to the solvent. Note that the sum T is calculated based on the following calculation expression: T=C1+C2.

To calculate the sum T, the secondary battery is disassembled to thereby take out the electrolytic solution, following which the electrolytic solution is analyzed by the ICP optical emission spectroscopy. The content C1 and the content C2 are thus identified, which allows for a calculation of the sum T.

In this case also, because the electrolytic solution includes the electrolyte salt, it is possible to achieve similar effects. In this case, in particular, when the electrolyte salt and the other electrolyte salt (lithium hexafluorophosphate) are used in combination, a total amount (the sum T) of the electrolyte salt and the other electrolyte salt is made appropriate. Therefore, the migration velocity of each of the cation and the lithium ion further improves in the vicinity of the surface of each of the positive electrode 21 and the negative electrode 22, and the migration velocity of each of the cation and the lithium ion further improves also in the electrolytic solution. Accordingly, it is possible to achieve higher effects.

As discussed above, the electrolytic solution includes lithium hexafluorophosphate as the other electrolyte salt according to an embodiment. However, the electrolytic solution may include lithium bis(fluorosulfonyl)imide instead of lithium hexafluorophosphate as the other electrolyte salt. In this case also, the content of the electrolyte salt in the electrolytic solution is preferably made appropriate in relation to the content of the other electrolyte salt in the electrolytic solution.

Specifically, lithium bis(fluorosulfonyl)imide includes a lithium ion and a bis(fluorosulfonyl)imide ion. In this case also, the sum T (mol/kg) of the content C1 of the cation in the electrolytic solution and the content C2 of the lithium ion in the electrolytic solution is preferably within the range from 0.6 mol/kg to 2.5 mol/kg both inclusive. One reason for this is that the migration velocity of each of the cation and the lithium ion sufficiently improves in the vicinity of the surface of each of the positive electrode 21 and the negative electrode 22, and the migration velocity of each of the cation and the lithium ion sufficiently improves also in the electrolytic solution, as described above.

In this case also, because the electrolytic solution includes the electrolyte salt, it is possible to achieve similar effects. In this case, in particular, when the electrolyte salt and the other electrolyte salt (lithium bis(fluorosulfonyl)imide) are used in combination, the total amount (the sum T) of the electrolyte salt and the other electrolyte salt is made appropriate. Therefore, the migration velocity of each of the cation and the lithium ion further improves in the vicinity of the surface of each of the positive electrode 21 and the negative electrode 22, and the migration velocity of each of the cation and the lithium ion further improves also in the electrolytic solution. Accordingly, it is possible to achieve higher effects.

The separator 23 that is a porous film is used. However, although not specifically illustrated here, a separator of a stacked type including a polymer compound layer may be used instead of the separator 23 that is the porous film.

Specifically, the separator of the stacked type includes a porous film having two opposed surfaces, and the polymer compound layer provided on one of or each of the two opposed surfaces of the porous film. This improves adherence of the separator to each of the positive electrode 21 and the negative electrode 22, and therefore suppresses misalignment of the battery device 20, that is, winding displacement of each of the positive electrode 21, the negative electrode 22, and the separator. This suppresses swelling of the secondary battery even if the decomposition reaction of the electrolytic solution occurs. The polymer compound layer includes, for example, polyvinylidene difluoride. One reason for this is that polyvinylidene difluoride is superior in physical strength and is electrochemically stable.

Note that the porous film, the polymer compound layer, or both may each include any one or more kinds of insulating particles. One reason for this is that the insulating particles dissipate heat upon heat generation by the secondary battery, thus improving safety or heat resistance of the secondary battery. The insulating particles include any one or more of insulating materials including, without limitation, an inorganic material and a resin material. Examples of the inorganic material include aluminum oxide, aluminum nitride, boehmite, silicon oxide, titanium oxide, magnesium oxide, and zirconium oxide. Examples of the resin material include acrylic resin and styrene resin.

To fabricate the separator of the stacked type, a precursor solution including, without limitation, the polymer compound and an organic solvent is prepared, following which the precursor solution is applied on one of or each of the two opposed surfaces of the porous film. In this case, the precursor solution may include the insulating particles.

When the separator of the stacked type is used also, lithium is movable in an ionic state between the positive electrode 21 and the negative electrode 22, and similar effects are therefore achievable. In this case, in particular, the swelling of the secondary battery is further suppressed by suppression of the misalignment of the battery device 20, as described above. Accordingly, it is possible to achieve higher effects.

The electrolytic solution that is a liquid electrolyte is used. However, although not specifically illustrated here, an electrolyte layer, which is a gel electrolyte, may be used.

In the battery device 20 including the electrolyte layer, the positive electrode 21 and the negative electrode 22 are wound, being opposed to each other with the separator 23 and the electrolyte layer interposed therebetween. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that leakage of the electrolytic solution is prevented. The configuration of the electrolytic solution is as described above. The polymer compound includes, for example, polyvinylidene difluoride. To form the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

When the electrolyte layer is used also, lithium ions are movable between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

Lastly, a description is given of applications (application examples) of the secondary battery.

The applications of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery pack may include a battery cell, or may include an assembled battery. The electric vehicle is a vehicle that travels with the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will now be described in detail. The configuration described below is merely an example, and is appropriately modifiable.

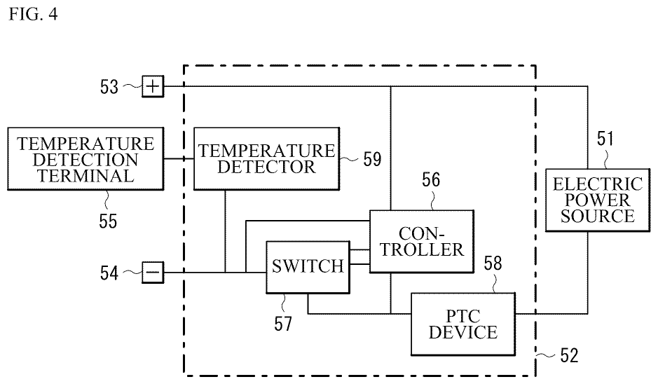

FIG. 4 illustrates a block configuration of a battery pack as the application example of the secondary battery. The battery pack described here is a battery pack (what is called a soft pack) including one secondary battery, and is to be mounted on, for example, electronic equipment typified by a smartphone.

As illustrated in FIG. 4, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (what is called a PTC device) 58, and a temperature detector 59. However, the PTC device 58 may be omitted.

The controller 56 includes, for example, a central processing unit (CPU) and a memory, and controls an overall operation of the battery pack. The controller 56 performs, for example, detection and control of a use state of the electric power source 51.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V±0.05 V. The overdischarge detection voltage is not particularly limited and is specifically 2.40±V 0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). Each of the charging current and the discharging current is detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

In Tables 1 to 12 to be described below, Example is represented by “Ex” and a comparative example is represented by “Com” for convenience. More specifically, for example, Example 1 is represented by “Ex1”, and Comparative example 1 is represented by “Com1”, to simplify the description.

### Examples 1 to 60 and Comparative Examples 1 to 6

Secondary batteries were manufactured, following which the secondary batteries were each evaluated for a battery characteristic as described below.

### [Fabrication of Secondary Battery]

The secondary batteries (lithium-ion secondary batteries) of the laminated-film type illustrated in FIGS. 1 to 3 were fabricated in accordance with the following procedure.

### [Fabrication of Positive Electrode]

First, 91 parts by mass of the positive electrode active material (LiNi_{0.82}Co_{0.14}Al_{0.04}O₂ as a lithium-containing compound (an oxide)), 3 parts by mass of the positive electrode binder (polyvinylidene difluoride), and 6 parts by mass of the positive electrode conductor (carbon black) were mixed with each other to thereby obtain a positive electrode mixture. Thereafter, the positive electrode mixture was put into a solvent (N-methyl-2-pyrrolidone as an organic solvent), following which the solvent was stirred to thereby prepare a positive electrode mixture slurry in paste form.

Thereafter, the positive electrode mixture slurry was applied on the two opposed surfaces of the positive electrode current collector 21A (a band-shaped aluminum foil having a thickness of 12 μm) by a coating apparatus, following which the applied positive electrode mixture slurry was dried to thereby form the positive electrode active material layers 21B. Thereafter, the positive electrode active material layers 21B were compression-molded by a roll pressing machine.

Lastly, as will be described later, the secondary battery was assembled, following which the stabilization process was performed using the assembled secondary battery. The positive electrode film 21C was thus formed on the surface of each of the positive electrode active material layers 21B. As a result, the positive electrode 21 was fabricated.

### [Fabrication of Negative Electrode]

First, 93 parts by mass of the negative electrode active material (artificial graphite as a carbon material) and 7 parts by mass of the negative electrode binder (polyvinylidene difluoride) were mixed with each other to thereby obtain a negative electrode mixture. Thereafter, the negative electrode mixture was put into a solvent (N-methyl-2-pyrrolidone as an organic solvent), following which the solvent was stirred to thereby prepare a negative electrode mixture slurry in paste form.

Thereafter, the negative electrode mixture slurry was applied on the two opposed surfaces of the negative electrode current collector 22A (a band-shaped copper foil having a thickness of 15 μm) by a coating apparatus, following which the applied negative electrode mixture slurry was dried to thereby form the negative electrode active material layers 22B. Thereafter, the negative electrode active material layers 22B were compression-molded by a roll pressing machine.

Lastly, as will be described later, the secondary battery was assembled, following which the stabilization process was performed using the assembled secondary battery. The negative electrode film 22C was thus formed on the surface of each of the negative electrode active material layers 22B. As a result, the negative electrode 22 was fabricated.

### [Preparation of Electrolytic Solution]

The electrolyte salt (the nitrogen-boron-containing lithium) was added to the solvent, following which the solvent was stirred. The electrolytic solution was thus prepared.

Used as the solvent was a mixture described below.

Firstly, used was a mixture of ethylene carbonate (EC) as a cyclic carbonic acid ester and γ-butyrolactone (GBL) as a lactone. In this case, a mixture ratio (a weight ratio) between ethylene carbonate and γ-butyrolactone in the solvent was set to 30:70.

Secondly, used was a mixture having a similar composition except that dimethyl carbonate (DMC) or diethyl carbonate (DEC) as a chain carbonic acid ester was used instead of the lactone.

Thirdly, used was a mixture having a similar composition except that propyl propionate (PrPr) or ethyl propionate (PrEt) as a chain carboxylic acid ester was used instead of the lactone.

A kind of the nitrogen-boron-containing lithium was as presented in Tables 1 to 7. In this case, the content (mol/kg) of the electrolyte salt in the electrolytic solution was changed by changing the added amount of the electrolyte salt.

For comparison, the electrolytic solution was prepared by a similar procedure except that another compound was used as the electrolyte salt instead of the nitrogen-boron-containing lithium. Used as the other compound were lithium hexafluorophosphate (LiPF₆), lithium bis(fluorosulfonyl)imide (LiFSI), lithium tetrafluoroborate (LiBF₄), and lithium trifluoro(trifluoromethyl)borate (LiBF₃(CF₃)).

### [Assembly of Secondary Battery]

First, the positive electrode lead 31 (an aluminum foil) was welded to the positive electrode current collector 21A of the positive electrode 21, and the negative electrode lead 32 (a copper foil) was welded to the negative electrode current collector 22A of the negative electrode 22.

Thereafter, the positive electrode current collector 21A on which the positive electrode active material layer 21B was formed and the negative electrode current collector 22A on which the negative electrode active material layer 22B was formed were stacked on each other with the separator 23 (a microporous polyethylene film having a thickness of 25 μm) interposed therebetween, to thereby form a stacked body. Thereafter, the stacked body was wound to thereby fabricate a wound body, following which the wound body is pressed by a pressing machine to thereby shape the wound body into an elongated shape.

Thereafter, the outer package film 10 (the fusion-bonding layer/the metal layer/the surface protective layer) was so folded as to sandwich the wound body placed in the depression part 10U. Thereafter, the outer edge parts of two sides of the fusion-bonding layer were thermal-fusion-bonded to each other to thereby allow the wound body to be contained inside the outer package film 10 having the pouch shape. As the outer package film 10, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from the inner side.

Lastly, the electrolytic solution was injected into the outer package film 10 having the pouch shape, following which the outer edge parts of the remaining one side of the fusion-bonding layer were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32. The wound body was thereby impregnated with the electrolytic solution.

Accordingly, the wound body was sealed in the outer package film 10. As a result, the secondary battery was assembled.

### [Stabilization Process of Assembled Secondary Battery]

The assembled secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of that value, 4.2 V, until a current reached 0.05 C. Upon discharging, the secondary battery was discharged with a constant current of 0.1 C until the voltage reached 2.5 V. Note that 0.1 C was a value of a current that caused a battery capacity (a theoretical capacity) to be completely discharged in 10 hours, and 0.05 C was a value of a current that caused the battery capacity to be completely discharged in 20 hours.

The positive electrode film 21C was thus formed on the surface of the positive electrode active material layer 21B, and the positive electrode 21 was fabricated as a result. In addition, the negative electrode film 22C was thus formed on the surface of the negative electrode active material layer 22B, and the negative electrode 22 was fabricated as a result. Accordingly, the electrochemically stabilized battery device 20 was fabricated, and the battery device 20 was sealed in the outer package film 10. As a result, the secondary battery was completed. A rated capacity (mAh) of the secondary battery was as listed in Tables 1 to 7.

After the completion of the secondary battery, the thickness T (μm), the volume density V (g/cm³), the spacing (nm) of the (002) plane of the carbon material (artificial graphite), the peak position N (eV), the peak position B (eV), and the content (mol/kg) of the electrolyte salt were checked, which revealed the results presented in Tables 1 to 7.

### [Evaluation of Battery Characteristic]

The secondary batteries were each evaluated for a battery characteristic (a cyclability characteristic, a storage characteristic, and a load characteristic) in accordance with the following procedure, which revealed the results presented in Tables 1 to 7.

### [Cyclability Characteristic]

First, the secondary battery was charged and discharged in a high-temperature environment (at a temperature of 60° C.) to thereby measure a discharge capacity (a first-cycle discharge capacity). Charging and discharging conditions were set to be similar to the charging and discharging conditions for the stabilization process of the secondary battery described above.

Thereafter, the secondary battery was repeatedly charged and discharged in the same environment until the total number of cycles reached 100 to thereby measure the discharge capacity (a 100th-cycle discharge capacity). Charging and discharging conditions were set to be similar to the charging and discharging conditions for the stabilization process of the secondary battery described above.

Lastly, a cycle retention rate as an index for evaluating the cyclability characteristic was calculated based on the following calculation expression: cycle retention rate (%)=(100th-cycle discharge capacity/first-cycle discharge capacity)×100.

### [Storage Characteristic]

First, the secondary battery was charged and discharged for one cycle in an ambient temperature environment (at a temperature of 23° C.) to thereby measure the discharge capacity (a pre-storage discharge capacity). Charging and discharging conditions were set to be similar to the charging and discharging conditions for the stabilization process of the secondary battery described above.

Thereafter, the secondary battery was charged in the same environment, and the charged secondary battery was stored (for a storage period of 10 days) in a high-temperature environment (at a temperature of 80° C.). Thereafter, the secondary battery was discharged in the ambient temperature environment to thereby measure the discharge capacity (a post-storage discharge capacity). Charging and discharging conditions were set to be similar to the charging and discharging conditions for the stabilization process of the secondary battery described above.

Lastly, a storage retention rate as an index for evaluating the storage characteristic was calculated based on the following calculation expression: storage retention rate (%)=(post-storage discharge capacity/pre-storage discharge capacity)×100.

### [Load Characteristic]

First, the secondary battery was charged and discharged for one cycle in an ambient temperature environment (at a temperature of 23° C.) to thereby measure the discharge capacity (a first-cycle discharge capacity). Charging and discharging conditions were set to be similar to the charging and discharging conditions for the stabilization process of the secondary battery described above.

Thereafter, the secondary battery was repeatedly charged and discharged in a low-temperature environment (at a temperature of −10° C.) until the total number of cycles reached 100 to thereby measure the discharge capacity (a 100th-cycle discharge capacity). Charging and discharging conditions were set to be similar to the charging and discharging conditions for the stabilization process of the secondary battery described above, except that the current at the time of discharging was changed to 1 C. Note that 1 C was a value of a current that caused the battery capacity to be completely discharged in 1 hour.

Lastly, a load retention rate as an index for evaluating the load characteristic was calculated based on the following calculation expression: load retention rate (%)=(100th-cycle discharge capacity/first-cycle discharge capacity)×100.

TABLE 1

| | Negative electrode | | | | | | | | | | | |
|---|---|---|---|---|---|---|---|---|---|---|---|---|
| | active material layer | | | | | | | | | | | |
| | Negative | | | | | | | | | | | |
| | electrode | | | | | | | Positive electrode film | | | | |
| | active | | | | | | | Negative electrode film | | | | |
| | material | | | | Rated | Electrolyte salt | | Peak | Peak | Cycle | Storage | Load |
| | (Carbon | T | V | S | capacity | | Content | position | position | retention | retention | retention |
| | material) | (μm) | (g/cm³) | (nm) | (mAh) | Kind | (mol/kg) | N (eV) | B (eV) | rate (%) | rate (%) | rate (%) |
| Ex1 | Artificial | 30 | 1.6 | 0.3358 | 2500 | LiB(CF₃)(CN)₃ | 1 | 400 | 193 | 85 | 80 | 65 |
| | graphite | | | | | | | | | | | |
| Ex2 | Artificial | 40 | 1.6 | 0.3358 | 2500 | LiB(CF₃)(CN)₃ | 1 | 400 | 193 | 84 | 79 | 50 |
| | graphite | | | | | | | | | | | |
| Ex3 | Artificial | 40 | 1.6 | 0.3362 | 2500 | LiB(CF₃)(CN)₃ | 1 | 400 | 193 | 84 | 77 | 50 |
| | graphite | | | | | | | | | | | |
| Ex4 | Artificial | 40 | 1.6 | 0.3372 | 2500 | LiB(CF₃)(CN)₃ | 1 | 400 | 193 | 83 | 76 | 49 |
| | graphite | | | | | | | | | | | |
| Ex5 | Artificial | 40 | 1.6 | 0.3380 | 2500 | LiB(CF₃)(CN)₃ | 1 | 400 | 193 | 83 | 75 | 47 |
| | graphite | | | | | | | | | | | |
| Ex6 | Artificial | 40 | 1.4 | 0.3358 | 2300 | LiB(CF₃)(CN)₃ | 1 | 400 | 193 | 88 | 79 | 52 |
| | graphite | | | | | | | | | | | |
| Ex7 | Artificial | 40 | 1.5 | 0.3358 | 2400 | LiB(CF₃)(CN)₃ | 1 | 400 | 193 | 86 | 79 | 52 |
| | graphite | | | | | | | | | | | |
| Ex8 | Artificial | 40 | 1.7 | 0.3358 | 2600 | LiB(CF₃)(CN)₃ | 1 | 400 | 193 | 80 | 77 | 46 |
| | graphite | | | | | | | | | | | |
| Ex9 | Artificial | 40 | 1.8 | 0.3358 | 2700 | LiB(CF₃)(CN)₃ | 1 | 400 | 193 | 60 | 70 | 30 |
| | graphite | | | | | | | | | | | |
| Ex10 | Artificial | 40 | 1.9 | 0.3358 | 2800 | LiB(CF₃)(CN)₃ | 1 | 400 | 193 | 58 | 68 | 26 |
| | graphite | | | | | | | | | | | |
| Ex11 | Artificial | 40 | 2 | 0.3358 | 3000 | LiB(CF₃)(CN)₃ | 1 | 400 | 193 | 55 | 65 | 23 |
| | graphite | | | | | | | | | | | |
| Ex12 | Artificial | 50 | 1.6 | 0.3358 | 2500 | LiB(CF₃)(CN)₃ | 1 | 400 | 193 | 82 | 79 | 48 |
| | graphite | | | | | | | | | | | |
| Ex13 | Artificial | 60 | 1.6 | 0.3358 | 2500 | LiB(CF₃)(CN)₃ | 1 | 400 | 193 | 80 | 79 | 45 |
| | graphite | | | | | | | | | | | |
| Ex14 | Artificial | 80 | 1.6 | 0.3358 | 2500 | LiB(CF₃)(CN)₃ | 1 | 400 | 193 | 72 | 76 | 40 |
| | graphite | | | | | | | | | | | |
| Ex15 | Artificial | 100 | 1.6 | 0.3358 | 2500 | LiB(CF₃)(CN)₃ | 1 | 400 | 193 | 65 | 76 | 35 |
| | graphite | | | | | | | | | | | |

TABLE 2

| | Negative electrode | | | | | | | | | | | |
|---|---|---|---|---|---|---|---|---|---|---|---|---|
| | active material layer | | | | | | | | | | | |
| | Negative | | | | | | | | | | | |
| | electrode | | | | | | | Positive electrode film | | | | |
| | active | | | | | | | Negative electrode film | | | | |
| | material | | | | Rated | Electrolyte salt | | Peak | Peak | Cycle | Storage | Load |
| | (Carbon | T | V | S | capacity | | Content | position | position | retention | retention | retention |
| | material) | (μm) | (g/cm³) | (nm) | (mAh) | Kind | (mol/kg) | N (eV) | B (eV) | rate (%) | rate (%) | rate (%) |
| Ex16 | Artificial | 30 | 1.6 | 0.3358 | 2500 | LiB(C₂F₅)(CN)₃ | 1 | 400 | 193 | 80 | 76 | 59 |
| | graphite | | | | | | | | | | | |
| Ex17 | Artificial | 40 | 1.4 | 0.3358 | 2300 | LiB(C₂F₅)(CN)₃ | 1 | 400 | 193 | 83 | 75 | 46 |
| | graphite | | | | | | | | | | | |
| Ex18 | Artificial | 40 | 1.5 | 0.3358 | 2400 | LiB(C₂F₅)(CN)₃ | 1 | 400 | 193 | 81 | 75 | 46 |
| | graphite | | | | | | | | | | | |
| Ex19 | Artificial | 40 | 1.6 | 0.3358 | 2500 | LiB(C₂F₅)(CN)₃ | 1 | 400 | 193 | 79 | 75 | 44 |
| | graphite | | | | | | | | | | | |
| Ex20 | Artificial | 40 | 1.7 | 0.3358 | 2600 | LiB(C₂F₅)(CN)₃ | 1 | 400 | 193 | 75 | 73 | 40 |
| | graphite | | | | | | | | | | | |
| Ex21 | Artificial | 40 | 1.8 | 0.3358 | 2700 | LiB(C₂F₅)(CN)₃ | 1 | 400 | 193 | 55 | 66 | 24 |
| | graphite | | | | | | | | | | | |
| Ex22 | Artificial | 40 | 1.9 | 0.3358 | 2800 | LiB(C₂F₅)(CN)₃ | 1 | 400 | 193 | 53 | 65 | 23 |
| | graphite | | | | | | | | | | | |
| Ex23 | Artificial | 40 | 2 | 0.3358 | 3000 | LiB(C₂F₅)(CN)₃ | 1 | 400 | 193 | 53 | 63 | 22 |
| | graphite | | | | | | | | | | | |
| Ex24 | Artificial | 50 | 1.6 | 0.3358 | 2500 | LiB(C₂F₅)(CN)₃ | 1 | 400 | 193 | 76 | 75 | 43 |
| | graphite | | | | | | | | | | | |
| Ex25 | Artificial | 60 | 1.6 | 0.3358 | 2500 | LiB(C₂F₅)(CN)₃ | 1 | 400 | 193 | 74 | 75 | 40 |
| | graphite | | | | | | | | | | | |
| Ex26 | Artificial | 80 | 1.6 | 0.3358 | 2500 | LiB(C₂F₅)(CN)₃ | 1 | 400 | 193 | 66 | 72 | 35 |
| | graphite | | | | | | | | | | | |
| Ex27 | Artificial | 100 | 1.6 | 0.3358 | 2500 | LiB(C₂F₅)(CN)₃ | 1 | 400 | 193 | 59 | 72 | 30 |
| | graphite | | | | | | | | | | | |

TABLE 3

| | Negative electrode | | | | | | | | | | | |
|---|---|---|---|---|---|---|---|---|---|---|---|---|
| | active material layer | | | | | | | | | | | |
| | Negative | | | | | | | | | | | |
| | electrode | | | | | | | Positive electrode film | | | | |
| | active | | | | | | | Negative electrode film | | | | |
| | material | | | | Rated | Electrolyte salt | | Peak | Peak | Cycle | Storage | Load |
| | (Carbon | T | V | S | capacity | | Content | position | position | retention | retention | retention |
| | material) | (μm) | (g/cm³) | (nm) | (mAh) | Kind | (mol/kg) | N (eV) | B (eV) | rate (%) | rate (%) | rate (%) |
| Ex28 | Artificial | 30 | 1.6 | 0.3358 | 2500 | LiBF(CF₃)(CN)₂ | 1 | 400 | 193 | 83 | 78 | 63 |
| | graphite | | | | | | | | | | | |
| Ex39 | Artificial | 40 | 1.4 | 0.3358 | 2300 | LiBF(CF₃)(CN)₂ | 1 | 400 | 193 | 86 | 77 | 50 |
| | graphite | | | | | | | | | | | |
| Ex30 | Artificial | 40 | 1.5 | 0.3358 | 2400 | LiBF(CF₃)(CN)₂ | 1 | 400 | 193 | 83 | 77 | 50 |
| | graphite | | | | | | | | | | | |
| Ex31 | Artificial | 40 | 1.6 | 0.3358 | 2500 | LiBF(CF₃)(CN)₂ | 1 | 400 | 193 | 81 | 77 | 48 |
| | graphite | | | | | | | | | | | |
| Ex32 | Artificial | 40 | 1.7 | 0.3358 | 2600 | LiBF(CF₃)(CN)₂ | 1 | 400 | 193 | 77 | 75 | 44 |
| | graphite | | | | | | | | | | | |
| Ex33 | Artificial | 40 | 1.8 | 0.3358 | 2700 | LiBF(CF₃)(CN)₂ | 1 | 400 | 193 | 58 | 68 | 28 |
| | graphite | | | | | | | | | | | |
| Ex34 | Artificial | 40 | 1.9 | 0.3358 | 2800 | LiBF(CF₃)(CN)₂ | 1 | 400 | 193 | 56 | 66 | 24 |
| | graphite | | | | | | | | | | | |
| Ex35 | Artificial | 40 | 2 | 0.3358 | 3000 | LiBF(CF₃)(CN)₂ | 1 | 400 | 193 | 53 | 63 | 23 |
| | graphite | | | | | | | | | | | |
| Ex36 | Artificial | 50 | 1.6 | 0.3358 | 2500 | LiBF(CF₃)(CN)₂ | 1 | 400 | 193 | 80 | 77 | 46 |
| | graphite | | | | | | | | | | | |
| Ex37 | Artificial | 60 | 1.6 | 0.3358 | 2500 | LiBF(CF₃)(CN)₂ | 1 | 400 | 193 | 78 | 77 | 43 |
| | graphite | | | | | | | | | | | |
| Ex38 | Artificial | 80 | 1.6 | 0.3358 | 2500 | LiBF(CF₃)(CN)₂ | 1 | 400 | 193 | 70 | 74 | 39 |
| | graphite | | | | | | | | | | | |
| Ex39 | Artificial | 100 | 1.6 | 0.3358 | 2500 | LiBF(CF₃)(CN)₂ | 1 | 400 | 193 | 63 | 74 | 33 |
| | graphite | | | | | | | | | | | |

TABLE 4

| | Negative electrode | | | | | | | | | | | |
|---|---|---|---|---|---|---|---|---|---|---|---|---|
| | active material layer | | | | | | | | | | | |
| | Negative | | | | | | | | | | | |
| | electrode | | | | | | | Positive electrode film | | | | |
| | active | | | | | | | Negative electrode film | | | | |
| | material | | | | Rated | Electrolyte salt | | Peak | Peak | Cycle | Storage | Load |
| | (Carbon | T | V | S | capacity | | Content | position | position | retention | retention | retention |
| | material) | (μm) | (g/cm³) | (nm) | (mAh) | Kind | (mol/kg) | N (eV) | B (eV) | rate (%) | rate (%) | rate (%) |
| Ex40 | Artificial | 30 | 1.6 | 0.3358 | 2500 | LiBF₂(CF₃)CN | 1 | 400 | 193 | 79 | 74 | 37 |
| | graphite | | | | | | | | | | | |
| Ex41 | Artificial | 40 | 1.4 | 0.3358 | 2300 | LiBF₂(CF₃)CN | 1 | 400 | 193 | 82 | 74 | 44 |
| | graphite | | | | | | | | | | | |
| Ex42 | Artificial | 40 | 1.5 | 0.3358 | 2400 | LiBF₂(CF₃)CN | 1 | 400 | 193 | 80 | 74 | 44 |
| | graphite | | | | | | | | | | | |
| Ex43 | Artificial | 40 | 1.6 | 0.3358 | 2500 | LiBF₂(CF₃)CN | 1 | 400 | 193 | 78 | 74 | 42 |
| | graphite | | | | | | | | | | | |
| Ex44 | Artificial | 40 | 1.7 | 0.3358 | 2600 | LiBF₂(CF₃)CN | 1 | 400 | 193 | 74 | 72 | 38 |
| | graphite | | | | | | | | | | | |
| Ex45 | Artificial | 40 | 1.8 | 0.3358 | 2700 | LiBF₂(CF₃)CN | 1 | 400 | 193 | 54 | 65 | 22 |
| | graphite | | | | | | | | | | | |
| Ex46 | Artificial | 40 | 1.9 | 0.3358 | 2800 | LiBF₂(CF₃)CN | 1 | 400 | 193 | 52 | 63 | 22 |
| | graphite | | | | | | | | | | | |
| Ex47 | Artificial | 40 | 2 | 0.3358 | 3000 | LiBF₂(CF₃)CN | 1 | 400 | 193 | 52 | 62 | 22 |
| | graphite | | | | | | | | | | | |
| Ex48 | Artificial | 50 | 1.6 | 0.3358 | 2500 | LiBF₂(CF₃)CN | 1 | 400 | 193 | 76 | 74 | 40 |
| | graphite | | | | | | | | | | | |
| Ex49 | Artificial | 60 | 1.6 | 0.3358 | 2500 | LiBF₂(CF₃)CN | 1 | 400 | 193 | 74 | 74 | 37 |
| | graphite | | | | | | | | | | | |
| Ex50 | Artificial | 80 | 1.6 | 0.3358 | 2500 | LiBF₂(CF₃)CN | 1 | 400 | 193 | 66 | 71 | 32 |
| | graphite | | | | | | | | | | | |
| Ex51 | Artificial | 100 | 1.6 | 0.3358 | 2500 | LiBF₂(CF₃)CN | 1 | 400 | 193 | 59 | 71 | 27 |
| | graphite | | | | | | | | | | | |
| Ex52 | Artificial | 100 | 1.6 | 0.3358 | 2500 | LiBF(CN)₃ | 1 | 400 | 194 | 53 | 64 | 23 |
| | graphite | | | | | | | | | | | |

TABLE 5

| | Negative electrode | | | | | | | | | | | |
|---|---|---|---|---|---|---|---|---|---|---|---|---|
| | active material layer | | | | | | | | | | | |
| | Negative | | | | | | | | | | | |
| | electrode | | | | | | | Positive electrode film | | | | |
| | active | | | | | | | Negative electrode film | | | | |
| | material | | | | Rated | Electrolyte salt | | Peak | Peak | Cycle | Storage | Load |
| | (Carbon | T | V | S | capacity | | Content | position | position | retention | retention | retention |
| | material) | (μm) | (g/cm³) | (nm) | (mAh) | Kind | (mol/kg) | N (eV) | B (eV) | rate (%) | rate (%) | rate (%) |
| Com1 | Artificial | 40 | 1.6 | 0.3358 | 2500 | LiPF₆ | 1 | — | — | 50 | 60 | 20 |
| | graphite | | | | | | | | | | | |
| Com2 | Artificial | 40 | 1.6 | 0.3358 | 2500 | LiFSI | 1 | 400 | — | 48 | 62 | 35 |
| | graphite | | | | | | | | | | | |
| Com3 | Artificial | 40 | 1.6 | 0.3358 | 2500 | LiBF₄ | 1 | — | 194 | 30 | 45 | 10 |
| | graphite | | | | | | | | | | | |
| Com4 | Artificial | 40 | 1.6 | 0.3358 | 2500 | LiBF₃(CF₃) | 1 | — | 193 | 45 | 52 | 20 |
| | graphite | | | | | | | | | | | |

TABLE 6

| | Negative electrode | | | | | | | | | | | |
|---|---|---|---|---|---|---|---|---|---|---|---|---|
| | active material layer | | | | | | | | | | | |
| | Negative | | | | | | | | | | | |
| | electrode | | | | | | | Positive electrode film | | | | |
| | active | | | | | | | Negative electrode film | | | | |
| | material | | | | Rated | Electrolyte salt | | Peak | Peak | Cycle | Storage | Load |
| | (Carbon | T | V | S | capacity | | Content | position | position | retention | retention | retention |
| | material) | (μm) | (g/cm³) | (nm) | (mAh) | Kind | (mol/kg) | N (eV) | B (eV) | rate (%) | rate (%) | rate (%) |
| Com5 | Artificial | 40 | 1.6 | 0.3358 | 2500 | LiB(CF₃)(CN)₃ | 0.05 | — | — | 30 | 40 | 5 |
| | graphite | | | | | | | | | | | |
| Com6 | Artificial | 40 | 1.6 | 0.3358 | 2500 | LiB(CF₃)(CN)₃ | 0.1 | — | — | 40 | 45 | 10 |
| | graphite | | | | | | | | | | | |
| Ex53 | Artificial | 40 | 1.6 | 0.3358 | 2500 | LiB(CF₃)(CN)₃ | 0.5 | 400 | 193 | 70 | 74 | 40 |
| | graphite | | | | | | | | | | | |
| Ex2 | Artificial | 40 | 1.6 | 0.3358 | 2500 | LiB(CF₃)(CN)₃ | 1 | 400 | 193 | 84 | 79 | 50 |
| | graphite | | | | | | | | | | | |
| Ex54 | Artificial | 40 | 1.6 | 0.3358 | 2500 | LiB(CF₃)(CN)₃ | 1.5 | 400 | 193 | 88 | 82 | 62 |
| | graphite | | | | | | | | | | | |
| Ex55 | Artificial | 40 | 1.6 | 0.3358 | 2500 | LiB(CF₃)(CN)₃ | 2 | 400 | 193 | 84 | 82 | 64 |
| | graphite | | | | | | | | | | | |
| Ex56 | Artificial | 40 | 1.6 | 0.3358 | 2500 | LiB(CF₃)(CN)₃ | 3 | 400 | 193 | 72 | 72 | 45 |
| | graphite | | | | | | | | | | | |

TABLE 7
Negative electrode active material (Carbon material) = Artificial
graphite, T = 40 μm, V = 1.6 g/cm³, S = 0.3358 nm, Rated capacity = 2500 mAh

| | | | | | Positive electrode film | | | | |
|---|---|---|---|---|---|---|---|---|---|
| | | | | | Negative electrode film | | | | |
| | Solvent | | Electrolyte salt | | Peak | Peak | Cycle | Storage | Load |
| | | Mixture ratio | | Content | position | position | retention | retention | retention |
| | Kind | (Weight ratio) | Kind | (mol/kg) | N (eV) | B (eV) | rate (%) | rate (%) | rate (%) |
| Ex2 | EC + GBL | 30:70 | LiB(CF₃)(CN)₃ | 1 | 400 | 193 | 84 | 79 | 50 |
| Ex57 | EC + DMC | 30:70 | LiB(CF₃)(CN)₃ | 1 | 400 | 193 | 90 | 83 | 62 |
| Ex58 | EC + DEC | 30:70 | LiB(CF₃)(CN)₃ | 1 | 400 | 193 | 87 | 80 | 48 |
| Ex59 | EC + PrPr | 30:70 | LiB(CF₃)(CN)₃ | 1 | 400 | 193 | 88 | 80 | 50 |
| Ex60 | Ec + PrEt | 30:70 | LiB(CF₃)(CN)₃ | 1 | 400 | 193 | 89 | 80 | 60 |

As indicated in Tables 1 to 7, each of the cycle retention rate, the storage retention rate, and the load retention rate varied greatly depending on the physical properties of the negative electrode film 22C and the configuration of the negative electrode active material layer 22B.

Specifically, when appropriate physical property conditions that the peak position N was within the range from 395 eV to 405 eV both inclusive and the peak position B was within the range from 188 eV to 198 eV both inclusive were satisfied (Examples 1 to 52), two or more of the cycle retention rate, the storage retention rate, or the load retention rate increased, as compared with when the appropriate physical property conditions were not satisfied (Comparative examples 1 to 4).

Further, when the appropriate physical property conditions were satisfied, if appropriate configuration conditions that the thickness T was within the range from 30 μm to 100 m both inclusive and the volume density V was within the range from 1.4 g/cm³ to 2 g/cm³ both inclusive, a high cycle retention rate, a high storage retention rate, and a high load retention rate were obtained.

In particular, when the appropriate configuration conditions were satisfied, the use of the nitrogen-boron-containing lithium as the electrolyte salt allowed the appropriate physical property conditions to be satisfied. As a result, a high cycle retention rate, a high storage retention rate, and a high load retention rate were obtained.

However, when the nitrogen-boron-containing lithium was used as the electrolyte salt, the physical property conditions varied depending on the content of the electrolyte salt in the electrolytic solution.

Specifically, when the appropriate configuration conditions were satisfied but the content of the electrolyte salt in the electrolytic solution was less than 0.5 mol/kg (Comparative examples 5 and 6), the appropriate physical property conditions were not satisfied. As a result, each of the cycle retention rate, the storage retention rate, and the load retention rate decreased. In contrast, when the appropriate configuration conditions were satisfied and the content of the electrolyte salt in the electrolytic solution was 0.5 mol/kg or greater (Examples 2 and 53 to 56), the appropriate physical property conditions were satisfied. As a result, each of the cycle retention rate, the storage retention rate, and the load retention rate increased.

In this case, when the content of the electrolyte salt in the electrolytic solution was within the range from 0.5 mol/kg to 2 mol/kg both inclusive, one or more of the cycle retention rate, the storage retention rate, or the load retention rate further increased.

Other than the above-described cases, when the appropriate physical property conditions and the appropriate configuration conditions were satisfied (Examples 1 to 60), the following tendencies were obtained.

Firstly, even if the kind of the nitrogen-boron-containing lithium was changed, a high cycle retention rate, a high storage retention rate, and a high load retention rate were obtained. Secondly, when the spacing S was 0.3372 nm or less, two or more of the cycle retention rate, the storage retention rate, or the load retention rate further increased. Thirdly, when the appropriate physical property conditions were satisfied also in relation to the positive electrode 21 (the positive electrode film 21C), a high cycle retention rate, a high storage retention rate, and a high load retention rate were obtained. Fourthly, even if the composition of the solvent was changed, a high cycle retention rate, a high storage retention rate, and a high load retention rate were obtained.

### Examples 61 to 78

Secondary batteries were fabricated by a procedure similar to that in Example 2, except that the other solvent or the other electrolyte salt were included in the electrolytic solution as indicated in Tables 8 and 9, following which the secondary batteries were each evaluated for a battery characteristic. In this case, the other solvent or the other electrolyte salt was added to the electrolytic solution, following which the electrolytic solution was stirred.

Details of the other solvent were as described below. Used as an unsaturated cyclic carbonic acid ester were vinylene carbonate (VC), vinylethylene carbonate (VEC), and methylene ethylene carbonate (MEC). Used as a fluorinated cyclic carbonic acid ester were monofluoroethylene carbonate (FEC) and difluoroethylene carbonate (DFEC). Used as a sulfonic acid ester were propane sultone (PS) as a cyclic monosulfonic acid ester, propene sultone (PRS) as the cyclic monosulfonic acid ester, and cyclodisone (CD) as a cyclic disulfonic acid ester. Succinic anhydride (SA) was used as a dicarboxylic acid anhydride. Propanedisulfonic anhydride (PSAH) was used as a disulfonic acid anhydride. Ethylene sulfate (DTD) was used as a sulfuric acid ester. Succinonitrile (SN) was used as a nitrile compound. Hexamethylene diisocyanate (HMI) was used as an isocyanate compound.

Used as the other electrolyte salt were lithium hexafluorophosphate (LiPF₆), lithium tetrafluoroborate (LiBF₄), lithium bis(fluorosulfonyl)imide (LiFSI), lithium bis(oxalato)borate (LiBOB), and lithium difluorophosphate (LiPF₂O₂).

A content (wt %) of the other solvent in the electrolytic solution and a content (wt %) of the other electrolyte salt in the electrolytic solution were as listed in Tables 8 and 9.

TABLE 8
Peak position N = 400 eV, Peak position B = 193 eV

| | Negative electrode | | | | | | | | | | | |
|---|---|---|---|---|---|---|---|---|---|---|---|---|
| | active material layer | | | | | | | | | | | |
| | Negative | | | | | | | | | | | |
| | electrode | | | | | | | | | | | |
| | active | | | | | | | | | | | |
| | material | | | | Rated | Electrolyte salt | | Other solvent | | Cycle | Storage | Load |
| | (Carbon | T | V | S | capacity | | Content | | Content | retention | retention | retention |
| | material) | (μm) | (g/cm³) | (nm) | (mAh) | Kind | (mol/kg) | Kind | (wt %) | rate (%) | rate (%) | rate (%) |
| Ex2 | Artificial | 40 | 1.6 | 0.3358 | 2500 | LiB(CF₃)(CN)₃ | 1 | — | — | 84 | 79 | 50 |
| | graphite | | | | | | | | | | | |
| Ex61 | Artificial | 40 | 1.6 | 0.3358 | 2500 | LiB(CF₃)(CN)₃ | 1 | VC | 1 | 96 | 89 | 48 |
| | graphite | | | | | | | | | | | |
| Ex62 | Artificial | 40 | 1.6 | 0.3358 | 2500 | LiB(CF₃)(CN)₃ | 1 | VEC | 1 | 94 | 87 | 50 |
| | graphite | | | | | | | | | | | |
| Ex63 | Artificial | 40 | 1.6 | 0.3358 | 2500 | LiB(CF₃)(CN)₃ | 1 | MEC | 1 | 96 | 89 | 50 |
| | graphite | | | | | | | | | | | |
| Ex64 | Artificial | 40 | 1.6 | 0.3358 | 2500 | LiB(CF₃)(CN)₃ | 1 | FEC | 5 | 98 | 87 | 50 |
| | graphite | | | | | | | | | | | |
| Ex65 | Artificial | 40 | 1.6 | 0.3358 | 2500 | LiB(CF₃)(CN)₃ | 1 | DFEC | 5 | 96 | 87 | 49 |
| | graphite | | | | | | | | | | | |
| Ex66 | Artificial | 40 | 1.6 | 0.3358 | 2500 | LiB(CF₃)(CN)₃ | 1 | PS | 1 | 87 | 91 | 49 |
| | graphite | | | | | | | | | | | |
| Ex67 | Artificial | 40 | 1.6 | 0.3358 | 2500 | LiB(CF₃)(CN)₃ | 1 | PRS | 1 | 86 | 90 | 48 |
| | graphite | | | | | | | | | | | |
| Ex68 | Artificial | 40 | 1.6 | 0.3358 | 2500 | LiB(CF₃)(CN)₃ | 1 | CD | 1 | 90 | 87 | 50 |
| | graphite | | | | | | | | | | | |
| Ex69 | Artificial | 40 | 1.6 | 0.3358 | 2500 | LiB(CF₃)(CN)₃ | 1 | SA | 0.5 | 90 | 91 | 47 |
| | graphite | | | | | | | | | | | |
| Ex70 | Artificial | 40 | 1.6 | 0.3358 | 2500 | LiB(CF₃)(CN)₃ | 1 | PSAH | 0.5 | 92 | 91 | 54 |
| | graphite | | | | | | | | | | | |
| Ex71 | Artificial | 40 | 1.6 | 0.3358 | 2500 | LiB(CF₃)(CN)₃ | 1 | DTD | 0.5 | 86 | 89 | 53 |
| | graphite | | | | | | | | | | | |
| Ex72 | Artificial | 40 | 1.6 | 0.3358 | 2500 | LiB(CF₃)(CN)₃ | 1 | SN | 1 | 85 | 91 | 50 |
| | graphite | | | | | | | | | | | |
| Ex73 | Artificial | 40 | 1.6 | 0.3358 | 2500 | LiB(CF₃)(CN)₃ | 1 | HMI | 1 | 87 | 89 | 50 |
| | graphite | | | | | | | | | | | |

TABLE 9
Peak position N = 400 eV, Peak position B = 193 eV

| | Negative electrode | | | | | | | | | | | |
|---|---|---|---|---|---|---|---|---|---|---|---|---|
| | active material layer | | | | | | | | | | | |
| | Negative | | | | | | | | | | | |
| | electrode | | | | | | | | | | | |
| | active | | | | | | | | | | | |
| | material | | | | Rated | Electrolyte salt | | Other solvent | | Cycle | Storage | Load |
| | (Carbon | T | V | S | capacity | | Content | | Content | retention | retention | retention |
| | material) | (μm) | (g/cm³) | (nm) | (mAh) | Kind | (mol/kg) | Kind | (wt %) | rate (%) | rate (%) | rate (%) |
| Ex2 | Artificial | 40 | 1.6 | 0.3358 | 2500 | LiB(CF₃)(CN)₃ | 1 | — | — | 84 | 79 | 50 |
| | graphite | | | | | | | | | | | |
| Ex74 | Artificial | 40 | 1.6 | 0.3358 | 2500 | LiB(CF₃)(CN)₃ | 1 | LiPF₆ | 1 | 92 | 89 | 52 |
| | graphite | | | | | | | | | | | |
| Ex75 | Artificial | 40 | 1.6 | 0.3358 | 2500 | LiB(CF₃)(CN)₃ | 1 | LiBF₄ | 1 | 89 | 84 | 50 |
| | graphite | | | | | | | | | | | |
| Ex76 | Artificial | 40 | 1.6 | 0.3358 | 2500 | LiB(CF₃)(CN)₃ | 1 | LiFSI | 1 | 91 | 87 | 55 |
| | graphite | | | | | | | | | | | |
| Ex77 | Artificial | 40 | 1.6 | 0.3358 | 2500 | LiB(CF₃)(CN)₃ | 1 | LiBOB | 0.5 | 94 | 91 | 48 |
| | graphite | | | | | | | | | | | |
| Ex78 | Artificial | 40 | 1.6 | 0.3358 | 2500 | LiB(CF₃)(CN)₃ | 1 | LiPF₂O₂ | 0.5 | 92 | 89 | 52 |
| | graphite | | | | | | | | | | | |

As indicated in Table 8, when the electrolytic solution included the other solvent (Examples 61 to 73), each of the cycle retention rate and the storage retention rate further increased while the load retention rate was kept high, as compared with when the electrolytic solution did not include the other solvent (Example 2).

Further, as indicated in Table 9, when the electrolytic solution included the other electrolyte salt (Examples 74 to 78), each of the cycle retention rate and the storage retention rate further increased while the load retention rate was kept high, as compared with when the electrolytic solution did not include the other electrolyte salt (Example 2).

### Examples 79 to 108 and Comparative Examples 7 to 28

Secondary batteries were fabricated, following which the secondary batteries were each evaluated for a battery characteristic, by a procedure almost similar to that in Example 2, except that lithium hexafluorophosphate (LiPF₆) or lithium bis(fluorosulfonyl)imide (LiFSI) were included as the other electrolyte salt in the electrolytic solution as indicated in Tables 10 to 13.

In this case, the other electrolyte salt was added to the solvent together with the electrolyte salt, following which the solvent was stirred. The content (mol/kg) of the electrolyte salt, the content (mol/kg) of the other electrolyte salt, and the sum T (mol/kg) were as listed in Tables 10 to 13.

TABLE 10
Negative electrode active material (Carbon material) = Artificial graphite, T = 40 μm, V = 1.6 g/cm³, S = 0.3358 nm

| | | | | | | Positive electrode film | | | | |
|---|---|---|---|---|---|---|---|---|---|---|
| | | | | | | Negative electrode film | | | | |
| | Electrolyte salt | | Other electrolyte salt | | | Peak | Peak | Cycle | Storage | Load |
| | | Content | | Content | Sum T | position | position | retention | retention | retention |
| | Kind | (mol/kg) | Kind | (mol/kg) | (mol/kg) | N (eV) | B (eV) | rate (%) | rate (%) | rate (%) |
| Com7 | LiB(CF₃)(CN)₃ | 0.05 | LiPF₆ | 0.1 | 0.15 | — | — | 30 | 38 | 8 |
| Com8 | LiB(CF₃)(CN)₃ | 0.1 | LiPF₆ | 0.1 | 0.2 | — | — | 38 | 44 | 10 |
| Com9 | LiB(CF₃)(CN)₃ | 0.2 | LiPF₆ | 0.1 | 0.3 | 400 | 193 | 46 | 54 | 15 |
| Ex79 | LiB(CF₃)(CN)₃ | 0.5 | LiPF₆ | 0.1 | 0.6 | 400 | 193 | 72 | 75 | 43 |
| Ex80 | LiB(CF₃)(CN)₃ | 1 | LiPF₆ | 0.1 | 1.1 | 400 | 193 | 88 | 86 | 57 |
| Ex81 | LiB(CF₃)(CN)₃ | 1.5 | LiPF₆ | 0.1 | 1.6 | 400 | 193 | 89 | 86 | 63 |
| Ex82 | LiB(CF₃)(CN)₃ | 2 | LiPF₆ | 0.1 | 2.1 | 400 | 193 | 85 | 84 | 68 |
| Com10 | LiB(CF₃)(CN)₃ | 0.05 | LiPF₆ | 0.5 | 0.55 | — | — | 40 | 46 | 12 |
| Com11 | LiB(CF₃)(CN)₃ | 0.1 | LiPF₆ | 0.5 | 0.6 | — | — | 44 | 50 | 17 |
| Ex83 | LiB(CF₃)(CN)₃ | 0.2 | LiPF₆ | 0.5 | 0.7 | 400 | 193 | 72 | 75 | 42 |
| Ex84 | LiB(CF₃)(CN)₃ | 0.5 | LiPF₆ | 0.5 | 1 | 400 | 193 | 84 | 80 | 52 |
| Ex85 | LiB(CF₃)(CN)₃ | 1 | LiPF₆ | 0.5 | 1.5 | 400 | 193 | 92 | 86 | 70 |
| Ex86 | LiB(CF₃)(CN)₃ | 1.5 | LiPF₆ | 0.5 | 2 | 400 | 193 | 90 | 86 | 71 |

TABLE 11
Negative electrode active material (Carbon material) = Artificial graphite, T = 40 μm, V = 1.6 g/cm³, S = 0.3358 nm

| | | | | | | Positive electrode film | | | | |
|---|---|---|---|---|---|---|---|---|---|---|
| | | | | | | Negative electrode film | | | | |
| | Electrolyte salt | | Other electrolyte salt | | | Peak | Peak | Cycle | Storage | Load |
| | | Content | | Content | Sum T | position | position | retention | retention | retention |
| | Kind | (mol/kg) | Kind | (mol/kg) | (mol/kg) | N (eV) | B (eV) | rate (%) | rate (%) | rate (%) |
| Com12 | LiB(CF₃)(CN)₃ | 0.05 | LiPF₆ | 1 | 1.05 | — | — | 48 | 58 | 20 |
| Com13 | LiB(CF₃)(CN)₃ | 0.1 | LiPF₆ | 1 | 1.1 | — | — | 49 | 59 | 20 |
| Ex87 | LiB(CF₃)(CN)₃ | 0.2 | LiPF₆ | 1 | 1.2 | 400 | 193 | 72 | 75 | 42 |
| Ex88 | LiB(CF₃)(CN)₃ | 0.5 | LiPF₆ | 1 | 1.5 | 400 | 193 | 85 | 82 | 53 |
| Ex89 | LiB(CF₃)(CN)₃ | 1 | LiPF₆ | 1 | 2 | 400 | 193 | 90 | 86 | 72 |
| Ex90 | LiB(CF₃)(CN)₃ | 1.5 | LiPF₆ | 1 | 2.5 | 400 | 193 | 88 | 85 | 70 |
| Com14 | LiB(CF₃)(CN)₃ | 0.05 | LiPF₆ | 1.5 | 1.55 | — | — | 49 | 59 | 32 |
| Com15 | LiB(CF₃)(CN)₃ | 0.1 | LiPF₆ | 1.5 | 1.6 | — | — | 50 | 58 | 38 |
| Ex91 | LiB(CF₃)(CN)₃ | 0.2 | LiPF₆ | 1.5 | 1.7 | 400 | 193 | 88 | 86 | 65 |
| Ex92 | LiB(CF₃)(CN)₃ | 0.5 | LiPF₆ | 1.5 | 2 | 400 | 193 | 90 | 87 | 72 |
| Ex93 | LiB(CF₃)(CN)₃ | 1 | LiPF₆ | 1.5 | 2.5 | 400 | 193 | 88 | 87 | 70 |
| Com16 | LiB(CF₃)(CN)₃ | 1.5 | LiPF₆ | 1.5 | 3 | — | — | 67 | 75 | 45 |
| Com17 | LiB(CF₃)(CN)₃ | 0.05 | LiPF₆ | 2 | 2.05 | — | — | 48 | 58 | 40 |

TABLE 12
Negative electrode active material (Carbon material) = Artificial graphite, T = 40 μm, V = 1.6 g/cm³, S = 0.3358 nm

| | | | | | | Positive electrode film | | | | |
|---|---|---|---|---|---|---|---|---|---|---|
| | | | | | | Negative electrode film | | | | |
| | Electrolyte salt | | Other electrolyte salt | | | Peak | Peak | Cycle | Storage | Load |
| | | Content | | Content | Sum T | position | position | retention | retention | retention |
| | Kind | (mol/kg) | Kind | (mol/kg) | (mol/kg) | N (eV) | B (eV) | rate (%) | rate (%) | rate (%) |
| Com18 | LiB(CF₃)(CN)₃ | 0.05 | LiFSI | 0.1 | 0.15 | — | — | 26 | 42 | 28 |
| Com19 | LiB(CF₃)(CN)₃ | 0.1 | LiFSI | 0.1 | 0.2 | — | — | 34 | 48 | 30 |
| Com20 | LiB(CF₃)(CN)₃ | 0.2 | LiFSI | 0.1 | 0.3 | 400 | 193 | 42 | 58 | 35 |
| Ex94 | LiB(CF₃)(CN)₃ | 0.5 | LiFSI | 0.1 | 0.6 | 400 | 193 | 68 | 79 | 50 |
| Ex95 | LiB(CF₃)(CN)₃ | 1 | LiFSI | 0.1 | 1.1 | 400 | 193 | 84 | 90 | 64 |
| Ex96 | LiB(CF₃)(CN)₃ | 1.5 | LiFSI | 0.1 | 1.6 | 400 | 193 | 85 | 90 | 70 |
| Ex97 | LiB(CF₃)(CN)₃ | 2 | LiFSI | 0.1 | 2.1 | 400 | 193 | 81 | 88 | 75 |
| Com21 | LiB(CF₃)(CN)₃ | 0.05 | LiFSI | 0.5 | 0.55 | — | — | 36 | 50 | 32 |
| Com22 | LiB(CF₃)(CN)₃ | 0.1 | LiFSI | 0.5 | 0.6 | — | — | 40 | 54 | 37 |
| Ex98 | LiB(CF₃)(CN)₃ | 0.2 | LiFSI | 0.5 | 0.7 | 400 | 193 | 68 | 79 | 57 |
| Ex99 | LiB(CF₃)(CN)₃ | 0.5 | LiFSI | 0.5 | 1 | 400 | 193 | 80 | 84 | 59 |
| Ex100 | LiB(CF₃)(CN)₃ | 1 | LiFSI | 0.5 | 1.5 | 400 | 193 | 88 | 89 | 77 |
| Ex101 | LiB(CF₃)(CN)₃ | 1.5 | LiFSI | 0.5 | 2 | 400 | 193 | 86 | 89 | 78 |

TABLE 13
Negative electrode active material (Carbon material) = Artificial graphite, T = 40 μm, V = 1.6 g/cm³, S = 0.3358 nm

| | | | | | | Positive electrode film | | | | |
|---|---|---|---|---|---|---|---|---|---|---|
| | | | | | | Negative electrode film | | | | |
| | Electrolyte salt | | Other electrolyte salt | | | Peak | Peak | Cycle | Storage | Load |
| | | Content | | Content | Sum T | position | position | retention | retention | retention |
| | Kind | (mol/kg) | Kind | (mol/kg) | (mol/kg) | N (eV) | B (eV) | rate (%) | rate (%) | rate (%) |
| Com23 | LiB(CF₃)(CN)₃ | 0.05 | LiFSI | 1 | 1.05 | — | — | 44 | 62 | 40 |
| Com24 | LiB(CF₃)(CN)₃ | 0.1 | LiFSI | 1 | 1.1 | — | — | 45 | 63 | 40 |
| Ex102 | LiB(CF₃)(CN)₃ | 0.2 | LiFSI | 1 | 1.2 | 400 | 193 | 68 | 79 | 49 |
| Ex103 | LiB(CF₃)(CN)₃ | 0.5 | LiFSI | 1 | 1.5 | 400 | 193 | 81 | 86 | 60 |
| Ex104 | LiB(CF₃)(CN)₃ | 1 | LiFSI | 1 | 2 | 400 | 193 | 90 | 90 | 79 |
| Ex105 | LiB(CF₃)(CN)₃ | 1.5 | LiFSI | 1 | 2.5 | 400 | 193 | 84 | 89 | 77 |
| Com25 | LiB(CF₃)(CN)₃ | 0.05 | LiFSI | 1.5 | 1.55 | — | — | 45 | 63 | 52 |
| Com26 | LiB(CF₃)(CN)₃ | 0.1 | LiFSI | 1.5 | 1.6 | — | — | 46 | 62 | 58 |
| Ex106 | LiB(CF₃)(CN)₃ | 0.2 | LiFSI | 1.5 | 1.7 | 400 | 193 | 84 | 88 | 72 |
| Ex107 | LiB(CF₃)(CN)₃ | 0.5 | LiFSI | 1.5 | 2 | 400 | 193 | 90 | 89 | 79 |
| Ex108 | LiB(CF₃)(CN)₃ | 1 | LiFSI | 1.5 | 2.5 | 400 | 193 | 84 | 88 | 77 |
| Com27 | LiB(CF₃)(CN)₃ | 1.5 | LiFSI | 1.5 | 3 | — | — | 63 | 79 | 52 |
| Com28 | LiB(CF₃)(CN)₃ | 0.05 | LiFSI | 2 | 2.05 | — | — | 44 | 62 | 47 |

When lithium hexafluorophosphate was used as the other electrolyte salt, results presented in Tables 10 and 11 were obtained. Specifically, when the appropriate configuration conditions were satisfied but the appropriate physical property conditions were not satisfied or the condition that the sum T was within the range from 0.6 mol/kg to 2.5 mol/kg both inclusive was not satisfied (Comparative examples 7 to 17), each of the cycle retention rate, the storage retention rate, and the load retention rate decreased. In contrast, when the appropriate configuration conditions were satisfied, the appropriate physical property conditions were satisfied, and the condition that the sum T was within the range from 0.6 mol/kg to 2.5 mol/kg both inclusive was satisfied (Examples 79 to 93), each of the cycle retention rate, the storage retention rate, and the load retention rate increased.

The tendencies regarding improvement and degradation described here were similarly obtained when lithium bis(fluorosulfonyl)imide was used as the other electrolyte salt (Examples 94 to 108 and Comparative examples 18 to 28), as indicated in Tables 12 and 13.

Based on the results presented in Tables 1 to 13, when: the negative electrode 22 included the negative electrode active material layer 22B and the negative electrode film 22C; the negative electrode film 22C included nitrogen and boron as constituent elements; the negative electrode active material layer 22B included the carbon material; the thickness T of the negative electrode active material layer 22B was within the range from 30 μm to 100 μm both inclusive; the volume density V of the negative electrode active material layer 22B was within the range from 1.4 g/cm³ to 2 g/cm³ both inclusive; the peak position N was within the range from 395 eV to 405 eV both inclusive; and the peak position B was within the range from 188 eV to 198 eV both inclusive, a high cycle retention rate, a high storage retention rate, and a high load retention rate were obtained. Therefore, each of the cyclability characteristic, the storage characteristic, and the load characteristic improved. Accordingly, a superior battery characteristic was achieved.

Although the present technology has been described herein with reference to one or more embodiments including Examples, the configuration of the present technology is not limited thereto, and is therefore modifiable in a variety of ways.

Specifically, the description has been given of the case where the secondary battery has a battery structure of the laminated-film type. However, the battery structure of the secondary battery is not particularly limited, and may be, for example, of a cylindrical type, a prismatic type, a coin type, or a button type.

Further, the description has been given of the case where the battery device has a device structure of a wound type. However, the device structure of the battery device is not particularly limited, and may be, for example, of a stacked type or a zigzag folded type. In the stacked type, the positive electrode and the negative electrode are alternately stacked on each other with the separator interposed therebetween. In the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

Note that the present technology may have any of the following configurations according to an embodiment.

<1>

A secondary battery including:
a positive electrode;
a negative electrode; and
an electrolytic solution, in which
the negative electrode includes a negative electrode active material layer and a negative electrode film that covers a surface of the negative electrode active material layer,
the negative electrode film includes nitrogen and boron as constituent elements,
the negative electrode active material layer includes a carbon material,
the negative electrode active material layer has a thickness of greater than or equal to 30 micrometers and less than or equal to 100 micrometers,
the negative electrode active material layer has a volume density of greater than or equal to 1.4 grams per cubic centimeter and less than or equal to 2 grams per cubic centimeter,
based on a surface analysis of the negative electrode by X-ray photoelectron spectroscopy, an N1s spectrum derived from nitrogen and a B1s spectrum derived from boron are detectable,
the N1s spectrum has a peak position within a range of greater than or equal to 395 electron volts and less than or equal to 405 electron volts, and
the B1s spectrum has a peak position within a range of greater than or equal to 188 electron volts and less than or equal to 198 electron volts.
   <2>

The secondary battery according to <1>, in which
the carbon material includes graphite, and
the graphite has spacing of a (002) plane of 0.3372 nanometers or less, the spacing of the (002) plane being measured by X-ray diffractometry.
   <3>

The secondary battery according to <1> or <2>, in which
the positive electrode includes a positive electrode active material layer and a positive electrode film that covers a surface of the positive electrode active material layer,
the positive electrode film includes nitrogen and boron as constituent elements,
based on a surface analysis of the positive electrode by the X-ray photoelectron spectroscopy, an N1s spectrum derived from nitrogen and a B1s spectrum derived from boron are detectable,
the N1s spectrum has a peak position within a range of greater than or equal to 395 electron volts and less than or equal to 405 electron volts, and
the B1s spectrum has a peak position within a range of greater than or equal to 188 electron volts and less than or equal to 198 electron volts.
   <4>

The secondary battery according to any one of <1> to <3>, in which
the electrolytic solution includes a solvent and an electrolyte salt, and
the electrolyte salt includes an anion represented by Formula (1),

B(R1)(R2)(R3)CN— (1)
where
each of R1, R2, and R3 is any one of a fluorine group, a cyano group, an alkyl group, a fluorinated alkyl group, a fluorinated ester group, or a fluorinated alkoxy group, and
at least one of R1, R2, or R3 is any one of the fluorine group, the fluorinated alkyl group, the fluorinated ester group, or the fluorinated alkoxy group.
   <5>

The secondary battery according to <4>, in which a content of the electrolyte salt in the electrolytic solution is greater than or equal to 0.5 moles per kilogram and less than or equal to 2 moles per kilogram with respect to the solvent.

<6>

The secondary battery according to <4> or <5>, in which the electrolytic solution further includes at least one of lithium hexafluorophosphate, lithium tetrafluoroborate, lithium bis(fluorosulfonyl)imide, lithium bis(oxalato)borate, or lithium difluorophosphate.

<7>

The secondary battery according to <4>, in which
the electrolytic solution further includes lithium hexafluorophosphate or lithium bis(fluorosulfonyl)imide,
the electrolyte salt includes a cation and the anion,
the lithium hexafluorophosphate includes a lithium ion and a hexafluorophosphate ion, the lithium bis(fluorosulfonyl)imide includes a lithium ion and a bis(fluorosulfonyl)imide ion, and
a sum of a content of the cation in the electrolytic solution and a content of the lithium ion in the electrolytic solution is greater than or equal to 0.6 moles per kilogram and less than or equal to 2.5 moles per kilogram.
   <8>

The secondary battery according to any one of <4> to <7>, in which the electrolytic solution further includes at least one of an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, or an isocyanate compound.

<9>

The secondary battery according to any one of <1> to <8>, in which the secondary battery includes a lithium-ion secondary battery.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution, wherein
the negative electrode includes a negative electrode active material layer and a negative electrode film that covers a surface of the negative electrode active material layer,
the negative electrode film includes nitrogen and boron as constituent elements,
the negative electrode active material layer includes a carbon material,
the negative electrode active material layer has a thickness of greater than or equal to 30 micrometers and less than or equal to 100 micrometers,
the negative electrode active material layer has a volume density of greater than or equal to 1.4 grams per cubic centimeter and less than or equal to 2 grams per cubic centimeter,
based on a surface analysis of the negative electrode by X-ray photoelectron spectroscopy, an N1s spectrum derived from nitrogen and a B1s spectrum derived from boron are detectable,
the N1s spectrum has a peak position within a range of greater than or equal to 395 electron volts and less than or equal to 405 electron volts, and
the B1s spectrum has a peak position within a range of greater than or equal to 188 electron volts and less than or equal to 198 electron volts.

2. The secondary battery according to claim 1, wherein
the carbon material includes graphite, and
the graphite has spacing of a (002) plane of 0.3372 nanometers or less, the spacing of the (002) plane being measured by X-ray diffractometry.

3. The secondary battery according to claim 1, wherein
the positive electrode includes a positive electrode active material layer and a positive electrode film that covers a surface of the positive electrode active material layer,
the positive electrode film includes nitrogen and boron as constituent elements,
based on a surface analysis of the positive electrode by the X-ray photoelectron spectroscopy, an N1s spectrum derived from nitrogen and a B1s spectrum derived from boron are detectable,
the N1s spectrum has a peak position within a range of greater than or equal to 395 electron volts and less than or equal to 405 electron volts, and
the B1s spectrum has a peak position within a range of greater than or equal to 188 electron volts and less than or equal to 198 electron volts.

4. The secondary battery according to claim 1, wherein
the electrolytic solution includes a solvent and an electrolyte salt, and
the electrolyte salt includes an anion represented by Formula (1),
B(R1)(R2)(R3)CN— (1)
where
each of R1, R2, and R3 is any one of a fluorine group, a cyano group, an alkyl group, a fluorinated alkyl group, a fluorinated ester group, or a fluorinated alkoxy group, and
at least one of R1, R2, or R3 is any one of the fluorine group, the fluorinated alkyl group, the fluorinated ester group, or the fluorinated alkoxy group.

5. The secondary battery according to claim 4, wherein a content of the electrolyte salt in the electrolytic solution is greater than or equal to 0.5 moles per kilogram and less than or equal to 2 moles per kilogram with respect to the solvent.

6. The secondary battery according to claim 4, wherein the electrolytic solution further includes at least one of lithium hexafluorophosphate, lithium tetrafluoroborate, lithium bis(fluorosulfonyl)imide, lithium bis(oxalato)borate, or lithium difluorophosphate.

7. The secondary battery according to claim 4, wherein
the electrolytic solution further includes lithium hexafluorophosphate or lithium bis(fluorosulfonyl)imide,
the electrolyte salt includes a cation and the anion,
the lithium hexafluorophosphate includes a lithium ion and a hexafluorophosphate ion,
the lithium bis(fluorosulfonyl)imide includes a lithium ion and a bis(fluorosulfonyl)imide ion, and
a sum of a content of the cation in the electrolytic solution and a content of the lithium ion in the electrolytic solution is greater than or equal to 0.6 moles per kilogram and less than or equal to 2.5 moles per kilogram.

8. The secondary battery according to claim 4, wherein the electrolytic solution further includes at least one of an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, or an isocyanate compound.

9. The secondary battery according to claim 1, wherein the secondary battery comprises a lithium-ion secondary battery.
